(19) United States
(12) Patent Application Publication
(10) Pub. No.: US 2005/0194535 A1
(43) Pub. Date: Sep. 8, 2005

(54) Sample surface inspection method and inspection system

(75) Inventors: Nobuharu Noji, Zushi-shi (JP); Keiichi Tohyama, Yokohama-shi (JP); Mamoru Nakasuji, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBARA CORPORATION, Tokyo (JP)

(21) Appl. No.: 11/073,039

(22) Filed: Mar. 7, 2005

(30) Foreign Application Priority Data
Mar. 8, 2004 (JP) 2004-64629

(51) Int. Cl. G01N 23/00; G21K 7/00

(52) U.S. Cl. 250/311

(57) ABSTRACT

An electron gun irradiates a sample with electron beam. A sample stage holds the sample. A detector detects the electron having the information on the surface of the sample through irradiation of the electron beam toward the sample. An image of the sample surface is created according to the electron detected by the detector. A comparison inspection is performed by comparing the created image with a reference image. An inspection system is controlled so as to inspect some area on the sample surface selectively. A selective inspection is enabled. In a semiconductor inspection system using the electron beam, throughput is improved.

### BACKGROUND OF THE INVENTION

1. Field of the Invention

The present invention relates to an inspection system or apparatus for inspecting a defect of a pattern formed on a surface of an object to be inspected, using electronic beams. The inspection system is used in the case of detecting a defect of a wafer, for example, in the semiconductor manufacturing process. The inspection system irradiates an inspection object with electronic beams, obtains or detects some electrons changing according to the aspect of the surface of the inspection object, and forms the image data. The obtained or detected electrons include secondary electrons, reflected electrons (including mirror electrons), and back scattered electrons, and transmitted electrons. The inspection system inspects an inspection object according to the formed image data. It inspects a pattern formed on the surface of an inspection object with high throughput. The invention relates to a device manufacturing method for manufacturing a device with a good yield by using the above inspection system. Further, the invention relates to an inspection system according to a image projective method using area beam and a device manufacturing method using the above system.

2. Background

The semiconductor process is now in the era of 100 nm design rule. The production form is shifting from the small item mass production represented by DRAM to the multi item small production like SOC (Silicon on chip). According to this, the number of manufacturing process is increasing, improvement in yield in every process is essential, and an inspection of a defect which is generated in the process becomes very important.

According to the higher integration of a semiconductor device and the finer patterning, an inspection system of high resolution and high throughput is required. In order to check a defect on a wafer substrate of 100 nm design rule, it is necessary to inspect a pattern defect in the wiring having the line width of 100 nm and less, and further to inspect a defect of a particle via. Further, it is necessary to check the electrical defect thereof. Therefore, resolution of 100 nm and less is required. According to an increase in the manufacturing process accompanying the higher integration of a device, the amount of inspection is increased. A higher throughput is accordingly required. Further, tendency toward multilayer of a device is accelerated. An inspection system is required to have a function of detecting a contact failure (electrical defect) of a via connecting wire between layers.

An optical defect inspection system is mainly used at the present. In a viewpoint of resolution and contact failure inspection, however, instead of the optical defect inspection system, a defect inspection system by using electron beam is supposed to be mainstream of the inspection system in the future. The electron beam typed defect inspection system, however, has a weak point. In a viewpoint of throughput, it is inferior to that of the optical type.

Therefore, required is the development of an inspection system which has high resolution and high throughput and can detect an electrical defect. A limit of resolution in the system of the optical type is said to be ½ of the wavelength of the using light. In an example of visible light which is put into practice, resolution is 0.2 μm and so.

In the type using the electron beams, generally, a scanning electron beam method (SEM method) is in practical use. Resolution is 0.1 μm and the inspection time is 8 hours/piece (200 mm wafer). The electron beam type is characterized by the electrical defect (cut-off and conductive failure of wiring and conductive failure of via). However, the inspection speed is very slow. A defect inspection system improved in inspection speed is expected.

Generally, an inspection system is very expensive and the throughput is lower than that of the other process device. Therefore, it is used after the important process in the present. The inspection system is used after, for example, etching or deposition, and for example, it is used after the CMP (chemical mechanical polishing) planarizing process.

An inspection system of scan (SEM) method by using electronic beams will be described. The inspection system of SEM method scans and irradiates a sample with the electronic beam narrowing (this beam diameter corresponds to resolution) as if drawing a line. While, the stage is moved in a direction vertical to the scanning direction of the electronic beam. A plane observation area is irradiated by the electronic beam. The scanning width of the electronic beam is generally 100 μm and so. Through irradiation of the electron beam (refer to as primary electron beam) narrowing, the secondary electron is generated from the sample. The secondary electron is detected by a detector. For example, the detector is a scintillator+photo-multiplier (photoelectron multiplier). For example, the detector is of (PIN diode type) semiconductor method. By combining the coordinate of the irradiation position and the amount of secondary electron (signal intensity), an image is created. The image is stored into the storage. Or it is supplied to the CRT (Brown tube).

The above is the principle of SEM (scanning type electron microscope). From the image obtained in this method, a defect of a semiconductor (generally Si) wafer is detected during the process. The inspection speed (corresponding to throughput) is determined by the amount of the primary electron beams (current value), the beam diameter, and the response speed of the detector. The current maximum value is 0.1 μm (it may be regarded the same as the resolution) of the beam diameter, 100 nA of the current value, 100 MHz of the response speed of the detector. In this case, the inspection speed is said to be about 8 hours per one wafer having a diameter of 20 cm. The inspection speed is fairly slower ( 1/20 and less) than in the optical method. This becomes a big problem. It is necessary to detect a defect of a device pattern in the design rule of 100 nm and less formed on a wafer at high speed. Specifically, it is necessary to detect a shape defect such as the line width of 100 nm and less and the via of diameter 100 nm and less. Further, it is necessary to detect an electrical defect and further a dust of 100 nm and less.

A scanning inspection system by using electron beams is disclosed in, for example, JP-A-2002-26093 (pages 3 and 4, FIG. 2), JP-A-2002-161948 (pages 4 to 6, FIG. 1), and JP-A-2000-161932 (pages 7 to 9, FIG. 2).

In the SEM typed inspection system, the above inspection speed is regarded as a limit. In order to speed up more, that is, to increase the throughput, a new method is necessary.

Depending on an inspection, it may be wanted that a system inspects only a critical portion of defect easily occurring in some cases. The critical portion is, for example, the boundary portion of the memory cell portion and the random logic portion in an inspection after lithography. Further, the critical portion is a memory cell portion, for example, where the pattern becomes dense and the line width very narrows. The above request occurs when a higher priority is given to the throughput than to the accuracy in the whole surface inspection. As for the inspection accuracy, accuracy to some degree needs to be satisfied by inspecting only the critical portion surely. When the defect-easily occurring position is restricted and only the portion is inspected, there is a case where inspection accuracy can be sufficiently assured. In this situation, a technique capable of inspecting only the critical portion selectively is thought to be convenient. Such a technique is supposed to also meet the demand for high throughput.

### SUMMARY OF THE INVENTION

An object of the invention is to provide an inspection method and an inspection system which can reply to a demand for high throughput.

One form of the invention is an electron beam system. This system comprises means for irradiating a sample with electron beam, a detector for detecting the electron having caught the information on the surface of the sample through the irradiation of the electron beam toward the sample, means for creating an image, according to the electron having caught the information on the surface of the sample, which is lead by the detector, and control means for inspecting some position on the sample surface selectively. The image creating means combines the detected electrons to create an image.

It is preferable that the electron having got the information on the surface of the sample is at least one of the secondary electron generated from the sample, the reflected electron, the back scattered electron, and the transmitted electron. The above electron is preferably the mirror electron reflected in the vicinity of the surface of the sample. The above electron is preferably the transmitted electron which goes through the sample.

A form of the invention is a sample surface inspection method for inspecting the surface of the sample. This method comprises: selecting some area on the sample surface as an inspecting area, irradiating the selected inspecting area with electronic beam, detecting electron having information on the sample surface, creating an image of the sample surface based on the detected electron, and performing a comparison inspection, comparing the created image with a reference image or a criterion image.

In the above selecting step, the inspecting area may be selected according to an instruction of a predetermined recipe.

In the above selecting step, the inspecting area may be selected by the unit of stripe in inspecting a substrate.

In the above irradiating step, a system may irradiate the sample with the electronic beam moving the electron beam or the sample so that the electron beam relatively shifts on the sample.

In the above detecting step, the electron may be detected by projecting the electron beam on a projection surface including a plurality of pixels.

In the above irradiating step, it may irradiate the inspecting area with the electron beam having such an area that the illumination area of the electron beam includes a plurality of pixels on a detector.

In the comparing step, an image of a die within the same stripe where the created image is created may be used as the reference (or criterion) image.

A form of the invention is a sample surface inspection method for inspecting the surface of a sample. This inspection method comprises: inspecting a small area arbitrarily selected on a sample by using electron beam to obtain an image of the small area, specifying an area having a lot of defects from the image of the small area, calculating and specifying an area supposed to be much defective on the whole surface of the sample, from the above area specified in the small area, and irradiating the area supposed to be much defective on the whole surface of the sample with the electron beam to inspect the surface of the sample.

A form of the invention is a sample surface inspection system for inspecting the surface of a sample. This system comprises an electron gun for irradiating a sample with electron beam, a sample stage for holding the sample, a detector for detecting the electron having information on the sample surface through irradiation of the electron beam toward the sample, an image creating unit for creating an image of the sample surface based on the electron detected by the detector, and a comparison inspection unit for comparing the created image with a reference or criterion image, and a controller for performing a control so as to inspect some area on the sample surface selectively.

Some area on the sample surface may be selected according to an instruction of a recipe.

Some area on the sample surface may be selected by the stripe unit in inspection.

The controller may control deflection of the electron beam and/or movement of the stage so as to irradiate the stripe on the sample with the electron beam.

The detector may be a CCD sensor or a TDI-CCD sensor.

The electron gun may irradiate the sample with the electron beam having an illumination area including a plurality of pixels.

The stage may sequentially move at least in one direction on an x-y surface during the inspection.

The sample surface inspection system may further comprise a calculation unit which specifies an area having a lot of defects from an image of some small area on the sample, calculates a positional relation between the above area and a die, and specifies an area supposed to be much defective on the whole sample.

Another form of the invention is a device manufacturing method comprising steps of a. preparing a wafer, b. performing a wafer process, c. inspecting the wafer passing through the process, according to the above inspection method, d. repeating the above steps of b and c, and e. assembling a device.

The inspection method or the inspection system according to the invention can inspect a defect on a substrate such as a wafer with high throughput.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a view showing the whole structure of semiconductor inspection system.

FIG. 2 is a view showing the structure of an inspection device.

FIG. 3 is a view showing the structure of the inspection device.

FIG. 4 is a view showing the structure of the inspection device.

FIG. 5 is a view showing the structure of the inspection device.

FIG. 6 is a view showing the structure of the inspection device.

FIG. 7 is a view showing the structure of the main portion of the inspection device.

FIG. 8 is a front view showing the semiconductor inspection system according to the embodiment.

FIG. 9 is a plan view showing the semiconductor inspection system according to the embodiment.

FIG. 10 is a view showing an example of the structure of a cassette holder.

FIG. 11 is a view showing a mini environment device.

FIG. 12 is a view showing a loader housing.

FIG. 13 is a view showing the electron optical system.

FIG. 14A is a view showing the electron optical system.

FIG. 14B is a view showing the sample irradiation dome.

FIG. 15 is a view showing the operation of the control system.

FIG. 16 is a view showing the operation of the control system.

FIG. 17A and FIG. 17B are views each showing the operation of the control system.

FIG. 18 is a view showing the operation of the control system.

FIG. 19 is a view showing the operation of the control system.

FIG. 20 is a view showing the operation of the control system.

FIG. 21 is a view showing the operation of the control system.

FIG. 22 is a view showing the alignment procedure.

FIG. 23 is a view showing the alignment procedure.

FIG. 24 is a view showing the alignment procedure.

FIG. 25 is a view showing the defect inspecting procedure.

FIG. 26 is a view showing the defect inspecting procedure.

FIG. 27 is a view showing the defect inspecting procedure.

FIG. 28A and FIG. 28B are views each showing the defect inspecting procedure.

FIG. 29 is a view showing the defect inspecting procedure.

FIG. 30A and FIG. 30B are views-showing the defect inspecting procedure.

FIG. 31A and FIG. 31B are views each showing the defect inspecting procedure.

FIG. 32 is a view showing the structure of the control system.

FIG. 33 is a view showing the structure of the user interface.

FIG. 34 is a view showing the procedure of the inspection.

FIG. 35 is a view showing the procedure of the inspection.

FIG. 36 is a view showing the setting of the dies to be inspected.

FIG. 37 is a view showing the setting of the inspecting area within a die.

FIG. 38 is a view showing the procedure of the inspection.

FIG. 39A and FIG. 39B are views each showing the procedure of the inspection.

FIG. 40 is a view showing an example of scan when there is only one inspecting die in the inspection procedure.

FIG. 41 is a view showing the inspection object.

FIG. 42 is a view showing the selective inspection according to the invention.

FIG. 43 is a view showing the selective inspection according to the invention.

FIG. 44 is a view showing the selective inspection according to the invention.

FIG. 45 is a view showing the selective inspection according to the invention.

FIG. 46 is a view showing the electron beam system.

FIG. 47 is a view showing a first electron irradiation method.

FIG. 48 is a view showing the structure having the inspection system connected to the product line.

FIG. 49 is a view showing an example of a semiconductor device manufacturing method by using the inspection system.

FIG. 50 is a view showing the detail of the lithography process.

### DETAILED DESCRIPTION

The following detailed description refers to the accompanying drawings. Although the description includes exemplary implementations, other implementations are possible and changes may be made to be the implementations described without departing from the spirit and scope of the invention. The following detailed description and the accompanying drawings do not limit the invention. Instead, the scope of the invention is defined by the appended claims.

1. Whole Structure

First, the whole structure of a preferred semiconductor inspection system will be described.

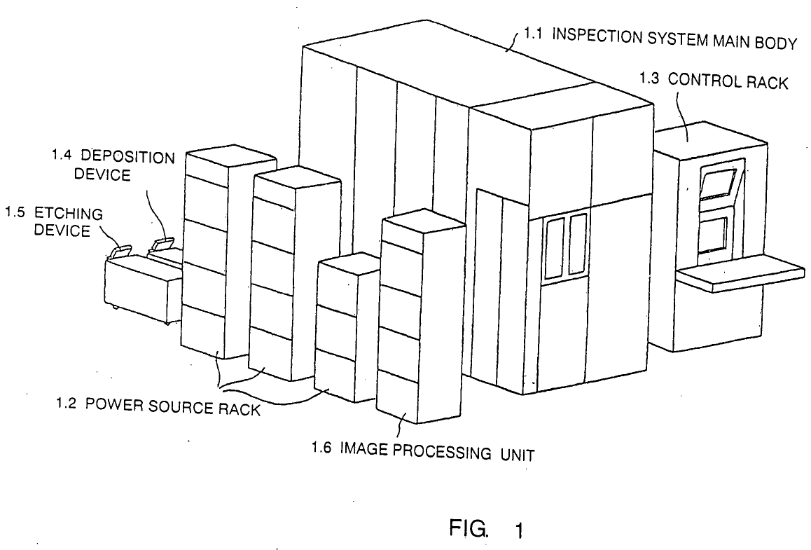

FIG. 1 shows the whole structure of the inspection system. The inspection system has a main body 1.1 of the inspection system, a power source rack 1.2, a control rack 1.3, a deposition device 1.4, an etching device 1.5, and an image processing unit 1.6. A roughing vacuum pump such as a dry vacuum pump is put outside of a clean room. The important portion of the inspection system body 1.1 is formed by an electron beam optical lens-column, a vacuum transfer system, a main housing including a stage, a vibration isolating table, a turbo molecular pump, and the like.

The control system has two CRTs and an instruction input function (keyboard). The above electron beam lens-column is principally formed by an electron optics system, a detection system, and an optical microscope. The electron optics system has an electron gun and lenses. The transfer system has a vacuum robot, an atmospheric transfer robot, a cassette loader, and various position sensors.

The deposition device, the etching device, and the cleaning equipment (not illustrated) are arranged near the main body 1.1 of the inspection system. They may be built in the main body. They are used, for example, in order to control electrostatic charge of a sample or to clean the surface of a sample. Use of the sputtering method can realize the both functions of deposition and etching.

Depending on the purpose of use of the inspection system, its relative units may be arranged near the main body although they are not illustrated. These relative units may be built in the main body, or the relative units may include the inspection system. For example, a chemical mechanical polishing device (CMP) and the cleaning equipment may be built in the main body of the inspection system, or a CVD (chemical vapor deposition) device may be built in the main body. In this case, the area for setting and the number of the units to be used for sample transfer can be saved and the transfer time can be shortened advantageously.

Similarly, the deposition device such as a metalizing device may be built in the main body. Similarly, a lithography device may be combined with the inspection system.

1-1) Main Chamber, Stage, Vacuum Transfer System Exteriof

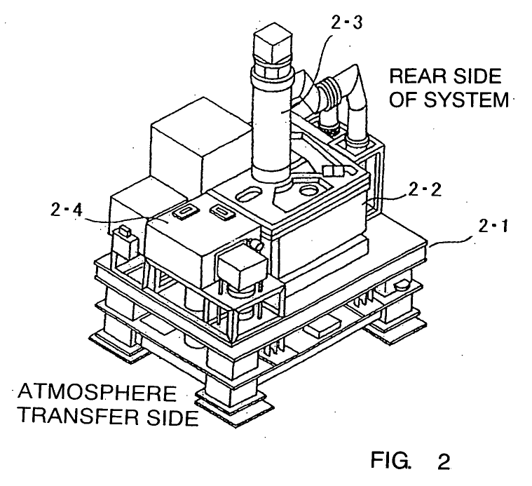

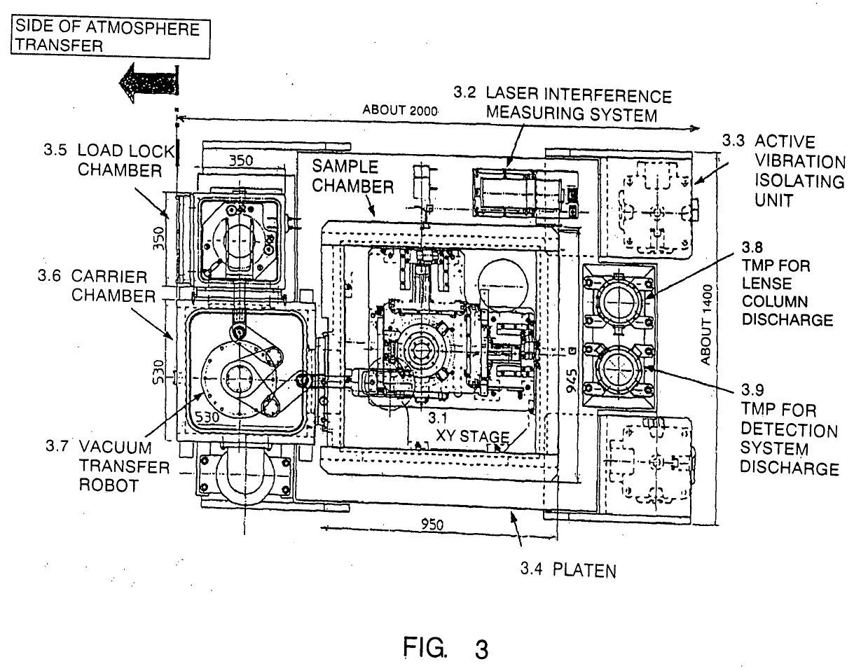

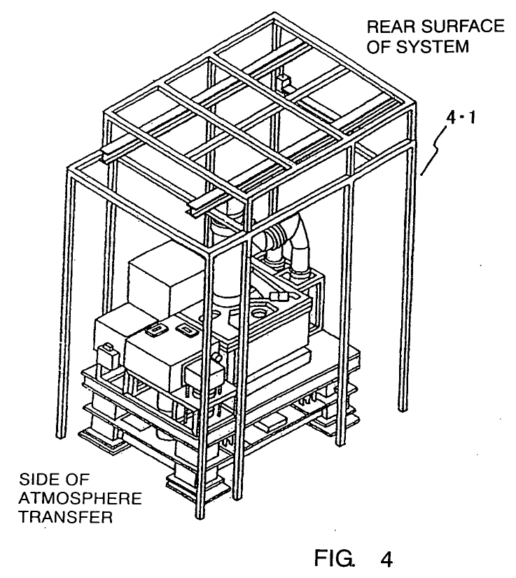

FIGS. 2, 3, and 4 show the components of the important portion of the inspection unit in the semiconductor inspection system. The inspection unit of the semiconductor inspection system comprises an active vibration isolating table 2.1, a main chamber 2.2, an electron optical device 2.3, an X-Y stage 3.1 for wafer scanning, a laser interference measuring system 3.2, and a vacuum transfer system 2.4. These are arranged in the positional relationship as shown in FIG. 2 and FIG. 3. The active vibration isolating table 2.1 isolates vibration caused by the outward environment. The main chamber 2.2 is an inspection chamber. The electron optical device 2.3 is put on the main chamber. The X-Y stage 3.1 is arranged within the main chamber and used for scanning a wafer. The laser interference measuring system 3.2 is used for controlling the operation of the X-Y stage. The vacuum transfer system 2.4 is attached to the main chamber. FIG. 2 and FIG. 3 show an active vibration isolating unit 3.3, a platen 3.4, a load lock chamber 3.5, a carrier chamber 3.6, a vacuum robot 3.7, a TMP 3.8 for lens-column discharge, and a TMP 3.9 for detecting system discharge. The inspection unit of the semiconductor inspection system further comprises an exterior 4.1 enabling environmental control and maintenance of the inspection unit. This is arranged in the positional relationship as shown in FIG. 4.

1-1-1) Active Vibration Isolating Table

A welding platen 3.4 is put on the active vibration isolating unit 2.3, in the active vibration isolating table 2.1. The active vibrating table 2.1 holds the main chamber 2.2 that is the inspection chamber, the electron optical device 2.3 put on the main chamber, and the vacuum transfer system 2.4 attached to the main chamber, on this welding platen. This can restrain the exterior vibration in the inspection unit.

1-1-2) Main Chamber

The main chamber 2.2 directly holds by the turbo molecular pump down in order to realize the vacuum (10⁻⁴ Pa and less) for the inspection environment. The main chamber 2.2 includes the accurate X-Y stage 3.1 for wafer scanning. The main chamber 2.2 can shield the external magnetism.

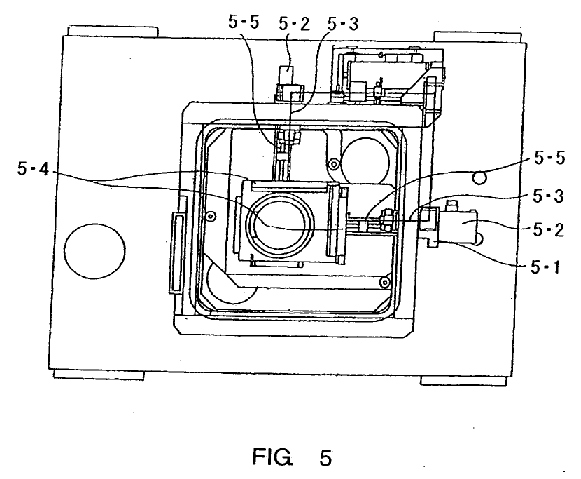

A stage-position measuring system like a laser interferometer is provided in order to control the X-Y stage with a high degree of accuracy. The interferometer 5.1 is arranged in vacuum in order to prevent a measurement error. In this embodiment, the interferometer is directly fixed to a rigid chamber wall so that the vibration of the interferometer itself, that can be the measurement error directly, should be close to zero. FIG. 5 shows a motor 5.2 for driving an X-Y axis, a magnetic fluid seal 5.3, mirrors 5.4, and ball screws 5.5.

1-1-3) X-Y Stage

The X-Y stage 3.1 is designed to be able to move a wafer in vacuum with a high degree of accuracy. For example, in a stage for 200 mm wafer, each of the X and Y strokes is 200 mm to 300 mm. In a stage for 300 mm wafer, each stroke is 300 mm to 600 mm.

In order to align a wafer in vacuum, a θ stage is arranged on the X-Y stage. In the θ stages in this embodiment, two ultrasonic motors are arranged as a driving unit. A linear scale is arranged in order to control the position. Various cables are connected to a moving part of performing the X, Y, and θ operations. These cables are clamped by cable bearings respectively attached to the X stage and the Y stage. These cables extend and connect to the outside of the main chamber through a field through set on the chamber wall.

1-2) Laser Interference Measuring System

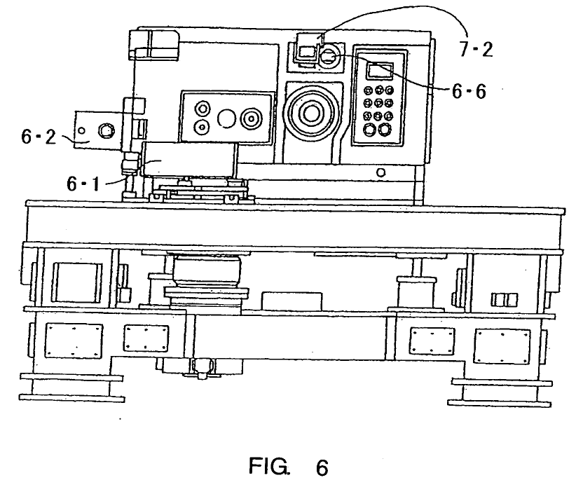

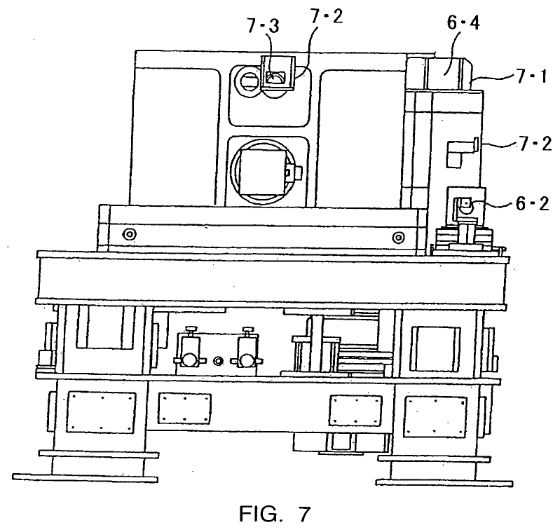

The laser interference measuring system is formed by the laser optical system and the interferometer 5.1. The optical axis of the laser optical system is in parallel to the X axis and the Y axis and the extending line of the optical axis corresponds to the inspection position. The interferometer 5.1 is put between the laser optical system and the inspection position. Each unit of the optical system in this embodiment is arranged as shown in FIG. 6 and FIG. 7. A laser 6.1 is put on the welding platen. Laser beam is emitted from the laser 6.1, raised up perpendicularly by a bender 6.2, and then, bent by a bender 7.1 in parallel to the measurement surface. The laser beam is divided into beam for X axis measurement and beam for Y axis measurement by a splitter 6.4. The laser beams are bent in parallel to the Y axis and the X axis respectively by a bender 7.3 and a bender 6.6, and introduced to the main chamber. FIG. 6 and FIG. 7 show several targets 7.2.

1-3) Inspection Unit Exterior

The inspection unit exterior 4.1 has a structure of frame for maintaining the unit in good condition. In this embodiment, an extensible straddle mounted crane is mounted on the upper portion. The crane is mounted on the transverse rails. The transverse rails are attached to driving rails (vertical). The driving rails are usually housed. Rising up at a maintenance time, the driving rails help enlarge a stroke of the crane in the vertical direction. Thus, at a maintenance time, by using the crane built in the exterior, the electron optical device 2.3, the top board of the main chamber, and the X-Y stage 3.1 can be removed from the rear side of the unit. In another embodiment of a crane built in the exterior, a rotatable cantilever crane is used.

The inspection unit exterior can also serve as an environment chamber. Depending on necessity, it may provide a magnetic shielding effect as well as a temperature and humidity control function.

2. Embodiments

Hereinafter, a preferred embodiment of the invention will be described. In the embodiment, an object to be inspected is a substrate with a pattern formed on its surface, that is, a wafer.

2-1) Transfer System

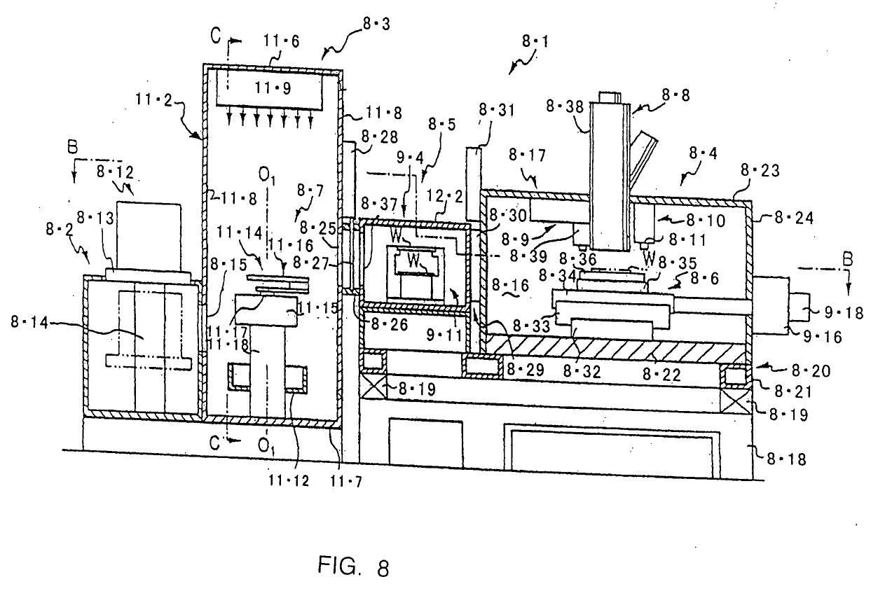

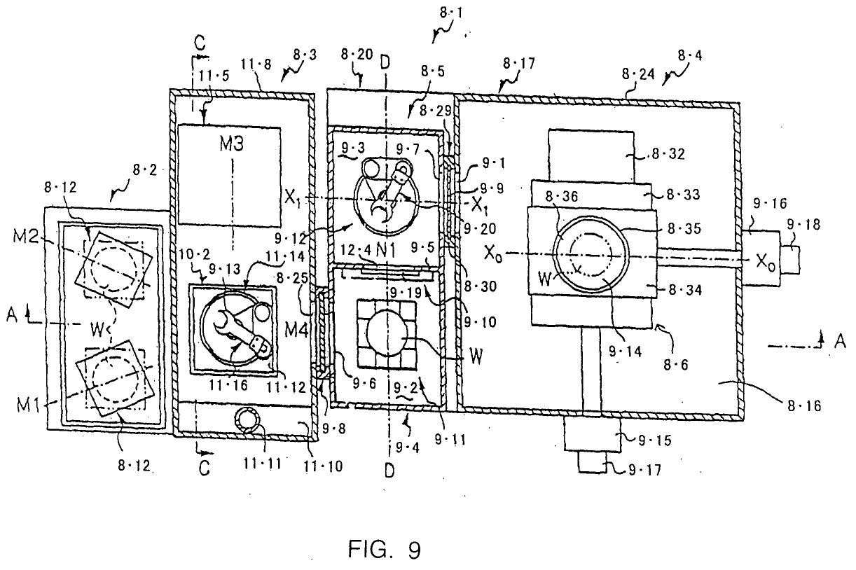

FIG. 8 and FIG. 9 show an elevation view and a plan view of the important components of the semiconductor inspection system. The semiconductor inspection system 8.1 comprises a cassette holder 8.2, a mini environment device 8.3, a loader housing 8.5, a loader 8.7, and an electron optical device 8.8. These are arranged in the positional relationship as shown in FIG. 8 and FIG. 9. The cassette holder 8.2 holds a cassette containing a plurality of wafers. The loader housing 8.5 forms a working chamber. The loader 8.7 loads a stage 8.6 with a wafer from the cassette holder 8.2. The stage 8.6 is arranged within the main housing 8.4. The electron optical device 8.8 is mounted on a vacuum housing.

The semiconductor inspection system 8.1 further comprises a pre-charge unit 8.9 arranged within the vacuum main housing 8.4, a potential applying mechanism which applies potential to a wafer, an electron beam calibration mechanism, an optical microscope 8.11 forming an alignment control device 8.10 for aligning a wafer on the stage.

2-1-1) Cassette Holder

The cassette holder 8.2 holds a plurality of cassettes 8.12. In this embodiment, two cassettes 8.12 are included there. Each of the cassettes 8.12 contains a plurality of wafers (for example, 25 wafers) in parallel in a vertical direction. It is a closed cassette like, for example, SMIF and FOUP of ASYST Technologies, INC.

A cassette may be transferred by a robot and automatically loaded into the cassette holder 8.2. In this case, a cassette holder 8.2 suitable for the above transfer and loading is provided. Alternatively, a cassette may be loaded manually into the holder. In this case, a cassette holder 8.2 of open cassette structure suitable for manual loading is provided. The apparatus of this embodiment is designed suitably to any type of the cassette holder 8.2 selected.

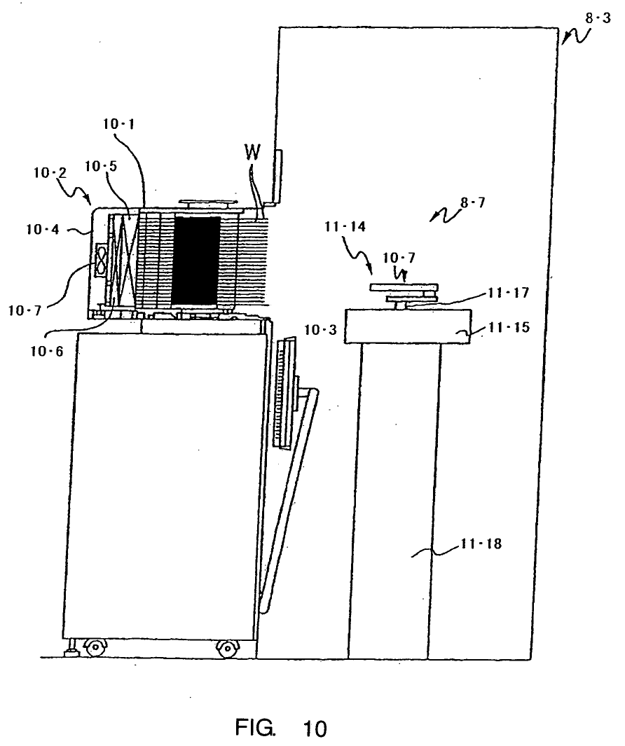

An example of the cassette in FIG. 10 comprises a case body 10.1, a substrate transfer box 10.2, a substrate transfer door 10.3, a cover 10.4, a ULPA filter 10.5, a chemical filter 10.6, and a fan motor 10.7.

2-1-2) Mini Environment Device

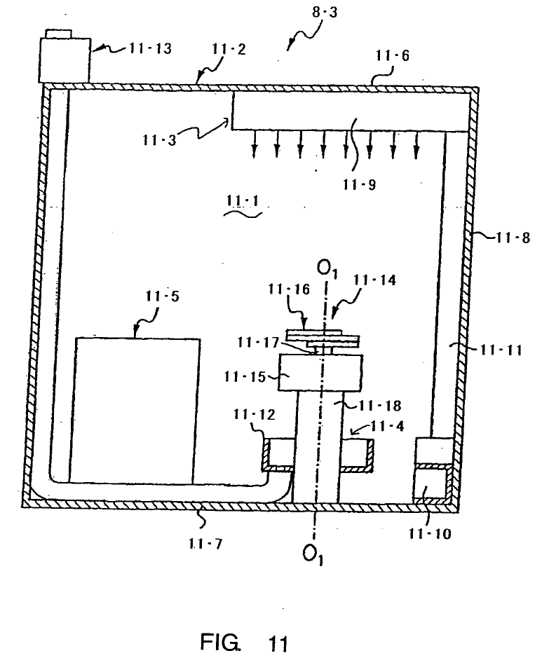

In FIG. 8 to FIG. 11, the mini environment device 8.3 comprises a housing 11.2, a gas circulation unit 11.3, a discharge unit 11.4, and a pre-aligner 11.5. The housing 11.2 forms a mini environment space 11.1 where atmosphere is controlled. The gas circulation unit 11.3 circulates a gas such as a clean air within the mini environment space 11.1 and controls the atmosphere. The discharge unit 11.4 collects a part of the air supplied to the mini environment space 11.1 and discharges it. The pre-aligner 11.5 is arranged within the mini environment space 11.1 and it roughly aligns a substrate, that is a wafer as the inspection object.

The housing 11.2 has a top wall 11.6, a bottom wall 11.7, and a side wall 11.8 surrounding around. The housing 11.2 has a structure of shielding the mini environment space 11.1 from the outside.

A hatch 8.15 is formed on the side wall 11.8 of the housing 11.2. The hatch 8.15 is provided in a portion adjacent to the cassette holder 8.2. A shutter of well-known structure may be provided in the vicinity of the hatch 8.15. The hatch 8.15 may be closed from the side of the mini environment device.

The pre-aligner 11.5 is arranged within the mini environment space 11.1. It detects orientation flat and notch formed on a wafer optically or mechanically. The orientation flat means a flat portion formed on the peripheral portion of a round wafer. The notch means at least one V shaped cut-off portion formed on the peripheral edge portion of a wafer. The pre-aligner 11.5 previously determines the rotation direction around the axis line O-O of a wafer with the accuracy of about ±1°.

2-1-3) Main Housing

In FIG. 8 and FIG. 9, the main housing 8.4 forms the working chamber 8.16. The main housing 8.4 includes a housing main body 8.17. The housing main body 8.17 is supported by a housing supporting device 8.20. The housing supporting device 8.20 is mounted on a vibration shielding device, that is, a vibration isolating device 8.19. The vibration isolating device 8.19 is put on a base frame 8.18.

The housing supporting device 8.20 has a frame structure 8.21 assembled to form a rectangular. The housing main body 8.17 is provided and fixed on the frame structure 8.21. It includes a bottom wall 8.22 which is put on the frame structure, a top wall 8.23, and a side wall 8.24. The side wall 8.24 is connected to the bottom wall 8.22 and the top wall 8.23, so to surround the chamber. The housing main body 8.17 works to isolate the working chamber 8.16 from the outside. In this embodiment, the bottom wall 8.22 is made by a comparatively thick steel plate. This structure prevents from distortion caused by the weight of each unit put above the bottom wall such as the stage. The bottom wall 8.22 may have another structure.

2-1-3) Loader Housing

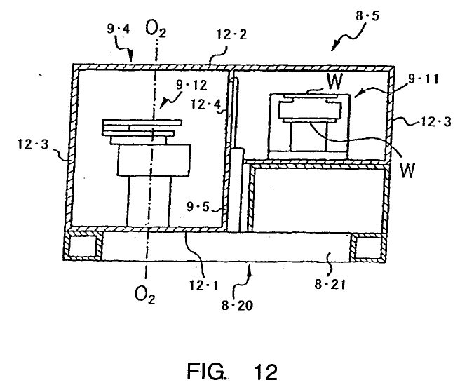

In FIGS. 8 and 9 and FIG. 12, the loader housing 8.5 has a housing main body 9.4. The housing main body 9.4 includes a first loading chamber 9.2 and a second loading chamber 9.3. The housing main body 9.4 has a bottom wall 12.1, a top wall 12.2, a side wall 12.3 surrounding around, and a partition wall 9.5. The partition wall 9.5 partitions the first loading chamber 9.2 and the second loading chamber 9.3. The housing main body 9.4 can isolate the both loading chambers from the outside. A hatch 12.4 is formed on the partition wall 9.5. The hatch 12.4 is provided in order to transfer a wafer between the both loading chambers. Hatches 9.6 and 9.7 are formed on the side wall 12.3. The hatches 9.6 and 9.7 are provided in the portions adjacent to the mini environment device and the main housing respectively.

2-1-5) Loader

The loader 8.7 is provided with a first robot-typed transfer unit 11.14 and a second robot-typed transfer unit 9.12. The first transfer unit 11.14 is arranged within the housing 11.2 of the mini environment device 8.3. The second transfer unit 9.12 is arranged within the second loading chamber 9.3.

The first transfer unit 11.14 has an arm 11.16 having a lot of joints. A driving unit 11.15 can rotate the arm 11.16 around the axis line O₁-O₁. The arm may have any structure. In this embodiment, the arm includes three portions rotatably connected to each other. A gripping device 9.13 is mounted on the distal end of the arm 11.16. The arm 11.16 is provided together with an axis 11.17 and a lifting mechanism 11.18.

This first transfer unit 11.14 transfers a wafer housed within the cassette. It transfers a wafer between the cassette and the pre-aligner 11.5, and further transfers between the pre-aligner 11.5 and the second loading chamber 9.2.

The second transfer unit 9.12 basically has the same structure as the first transfer unit. The second transfer unit 9.12 is different from the first transfer unit in that it transfers a wafer between a wafer rack and a mounting surface of the stage.

2-1-6) Stage

The stage 8.6 has a fixed table 8.32, a Y table 8.33, an X table 8.34, a rotation table 8.35, and a holder 8.36. The fixed table 8.32 is arranged on the bottom wall 8.22 of the main housing 8.4. The Y table 8.33 moves on the fixed table in the Y direction (direction perpendicular to the paper surface in FIG. 1). The X table 8.34 moves on the Y table in the X direction (horizontal direction in FIG. 1). The rotation table 8.35 can be rotated on the X table. The holder 8.36 is arranged on the rotation table 8.35. A wafer is put on a wafer mounting surface 9.14 of the holder 8.36 in a releasable way. The holder 8.36 may be designed in the well-known structure so that it can hold a wafer mechanically or in an electrostatic chucking method in a releasable way.

The stage 8.6 moves the above tables by using a servo motor, an encoder, and various kinds of sensors (not illustrated). The stage 8.6 aligns a wafer supported by the holder on the mounting surface 9.14. It aligns a wafer in the X direction, the Y direction, and the Z direction (vertical direction in FIG. 8) with respect to the electron beams. The electron beams are emitted from the electron optical device. Further, the stage 8.6 aligns a wafer in a direction (θ direction) of rotating around the axis line perpendicular to the supporting surface of the wafer at a high degree of accuracy. FIG. 9 shows the servo motors 9.14 and 9.15 for the stage and the encoders 9.17 and 9.18.

For example, it is possible to fine adjust the position of the mounting surface on the holder in the Z direction, in order to align a wafer in the Z direction. In this case, a reference position on the mounting surface is detected by a position measuring device using a fine diameter laser (laser interference measuring device using the principle of an interferometer). The position is controlled by a feedback circuit which is not illustrated. The position of the notch or the orientation flat of a wafer is measured together with this control or instead of this control. Thus, the position of the plain surface and the rotation position of a wafer with respect to the electron beams are detected. The rotation table is rotated by a stepping motor capable of controlling a fine angle, hence to control the position.

The rotation position and the X and Y positions of a wafer with respect to the electron beams may be entered into the signal detecting system or the image processing system previously. Thus, a signal is standardized. Further, a wafer chuck mechanism provided in this holder is designed so as to apply a voltage for chucking a wafer to the electrode of the electrostatic chuck. Three points of the peripheral portion of a wafer (preferably, they are provided at regular intervals in the peripheral direction) are fixed for the alignment. The wafer chuck mechanism has two fixedly positioning pins and one pressing crankpin. The crankpin is formed so as to realize automatic chuck and automatic release, and it has a conductive portion for voltage application.

In this embodiment, the horizontally moving table in FIG. 9 is the X table. The vertically moving table is the Y table. However, the horizontally moving table in FIG. 9 may be the Y table and the vertically moving table may be the X table.

2-2) Transfer Method of Wafer

This time, the procedure for wafer transfer will be described sequentially (refer to FIG. 8 to FIG. 12). A wafer is transferred from the cassette 8.12 held by the cassette holder 8.2 to the stage 8.6 arranged within the working chamber 8.16.

As mentioned above, when a cassette is set manually, the cassette holder 8.2 designed suitably for the manual setting is used. When a cassette is automatically set, the cassette holder 8.2 designed suitably for the automatic setting is used. In this embodiment, when a cassette 8.12 is set on the lifting table 8.13 of the cassette holder 8.2, the lifting table 8.13 is moved down by the lifting mechanism 8.14, and the cassette 8.12 is disposed at a position corresponding to the hatch 8.15. When the cassette comes to the hatch 8.15, a cover (not illustrated) provided on the cassette opens. A cylindrical cover is arranged between the cassette and the hatch 8.15 of the mini environment device 8.3. This shields the cassette and the mini environment space from the outside. As the structure is well known, the detailed description of the structure and the operation is omitted. When a shutter for opening and closing the hatch 8.15 is provided on the side of the mini environment device 8.3, the shutter operates to open the hatch 8.15.

While, the arm 11.16 of the first transfer unit 11.14 stops facing to the direction M1 or M2 (in this description, the direction M1). When the hatch 8.15 opens, the arm is extended and the distal end of the arm receives one of the wafers housed within the cassette. Vertical positioning adjusting is performed between the arm and the wafer to be taken from the cassette. This positioning adjustment is performed by the vertical movement of the driving unit 11.15 and the arm 11.16 of the first transfer unit 11.14. The positioning adjustment may be performed by vertical movement of the lifting table of the cassette holder. Alternatively, it may be performed by the above two operations.

When a wafer has been received by the arm 11.16, the arm is retracted and the shutter operates to close the hatch (when there is a shutter). The arm 11.16 rotates around the axis line O₁-O₁ and extends in the direction M3. A wafer is put on the distal end of the arm, or a wafer is clamped by a chuck. The wafer is put on the pre-aligner 11.5. The pre-aligner 11.5 aligns the rotation direction of the wafer (the direction around the central axis line perpendicular to the wafer surface) within a predetermined range. Upon completion of the alignment, the transfer unit 11.14 receives the wafer from the pre-aligner 11.5 by the distal end of the arm. The transfer unit 11.14 retracts the arm and this time it is in a position to extend the arm in the direction M4. A door 8.27 of the shutter 9.8 moves to open the hatches 8.25 and 8.37. The arm 11.16 extends to put the wafer on the upper portion or the lower portion of the wafer rack 9.11 within the first loading chamber 9.2. As mentioned above, the hatch 12.4 is closed before the shutter 9.8 opens to hand the wafer to the wafer rack 9.11. The hatch 12.4 is formed on the partition wall 9.5. It is sealed by the door 9.19 of the shutter 9.10. Sealing material 8.26 and a driving device 8.28 are provided in the shutter 9.8.

In the wafer transfer process by the first transfer unit 11.14, a clean air flows like laminar air flow (as down flow) from a gas supply unit 11.9 which is provided on the housing of the mini environment device 8.3. The air flow prevents dust from attaching to the top surface of a wafer on the transfer way. A conduit 11.11 is provided together with the gas supply unit 11.9. One of the airs around the transfer unit (mainly about 20% dirty air of the air supplied from the supply unit in this embodiment) is sucked into a suction duck 11.12 and discharged out of the housing. The remaining air is collected by the callback duct 11.10 provided on the bottom of the housing and returned to the gas supply unit 11.9 again.

A wafer is put into the wafer rack 9.11 within the first loading chamber 9.2 of the loader housing 8.5 by the first transfer unit 11.14. The shutter 9.8 is closed and the loading chamber 9.2 is sealed. The first loading chamber 9.2 is fully charged with inactive gas so that the air is discharged there. Then, the inactive gas is also discharged and the loading chamber 9.2 becomes vacuum. The vacuum degree of this first loading chamber 9.2 may be low. When this first loading chamber 9.2 becomes a certain degree of vacuum, the shutter 9.10 operates to open the shutter 9.5 of the hatch 12.4 sealed by the door 9.19. The arm 9.20 of the second transfer unit 9.12 extends and the gripping device in the distal end portion of the arm receives one wafer from the wafer rack 9.11. The wafer is put on the distal end portion of the arm. Alternatively, the wafer is gripped by a chuck mounted on the distal end portion of the arm. Upon completion of transfer of the wafer, the arm is retracted and the shutter 9.10 operates again, to close the hatch 12.4 by using the door 9.19.

Before the shutter 9.10 opens, the arm 9.20 is in a state of being extensible in the direction N1 of the wafer rack 9.11. As mentioned above, before the shutter 9.10 opens, the door 9.9 of the shutter 8.29 closes the hatches 9.7 and 9.1. This structure prevents from communication between the second loading chamber 9.3 and the working chamber 8.16 in a sealing way. Vacuum pumping is performed within the second loading chamber 9.3. A sealing material 30.30 and a driving device 13.31 are provided in the shutter 8.29.

When the shutter 9.10 closes the hatch 12.4, vacuum pumping is again performed within the second loading chamber 9.3. The second loading chamber 9.3 becomes vacuum at a higher degree than the first loading chamber 9.2. In the meantime, the arm of the second transfer unit 11.14 rotates at a position capable of extending in a direction toward the stage 8.6 within the working chamber 8.16. The Y table 8.33 moves upwardly in the stage 8.6 within the working chamber 8.16, in FIG. 9. The Y table 8.33 moves to the position where the central line X₀-X₀ of the X table 8.34 substantially conforms to the X axis line X₁-X₁ passing through the rotation axis line O₂-O₂ of the second transfer unit 9.12. The X table 8.34 moves to the utmost left position in FIG. 9. The X table 8.34 is waiting in this state. When the second loading chamber 9.3 gets at the same degree of vacuum as the working chamber 8.16, the door 9.9 of the shutter 8.29 operates to open the hatches 9.7 and 9.1 and the arm extends therefrom. The distal end of the arm grips a wafer and approaches the stage 8.6 within the working chamber 8.16. The wafer is put on the mounting surface 9.14 of the stage 8.6. Upon completion of mounting a wafer, the arm is retracted and the shutter 8.29 closes the hatches 9.7 and 9.1.

The stage has a mechanism of applying a reverse bias potential (retarding potential) to a wafer. When the arm moves to the stage to put a wafer thereon or when it moves to take the wafer therefrom, the potential of the arm is made at the same as that of the stage or close to that of the stage. Alternatively, the potential of the arm may be made at a floating potential. This mechanism prevents from disadvantage such as discharge caused by the short-circuit of the potential. In another embodiment, when a wafer is transferred to the stage, a bias potential to the wafer may be turned off.

When the bias potential is controlled, the potential is turned off until a wafer has been transferred to the stage. When a wafer has been transferred to the stage and put there, the potential may be turned on and the bias potential may be applied there. As for the timing of applying a bias potential, a tact time is previously set, and the potential may be applied according to the time. Alternatively, a sensor may detect that a wafer has been put on the stage and its detection signal of the sensor may trigger the application of the potential. Or a sensor may detect that the shutter 8.29 closes the hatches 9.7 and 9.1, and its detection signal may trigger the application of the potential. Further, in the case of using the electrostatic chuck, it must be confirmed that a wafer has been attached to the electrostatic chuck. This confirmation may trigger the application of the bias potential.

The above description is concerned about the operations up to the transfer of a wafer from the cassette 8.12 to the stage. Upon completion of the processing of a wafer put on the stage 8.6, the wafer is returned from the stage 8.6 to the cassette 8.12. At this time, the operations contrary to the above operations are performed. Since several wafers are put in the wafer rack 9.11, the second transfer unit 9.12 transfers a wafer between the wafer rack 9.11 and the stage 8.6. In the meantime, the first transfer unit 11.14 may transfer a wafer between the cassette and the wafer rack 9.11. In this case, the inspection processing can be performed more efficiently.

More concretely, when there is a wafer A already processed and a wafer B not processed in the wafer rack 9.11, at first, a not-processed wafer B is transferred to the stage 8.6. While, the processed wafer A is transferred from the wafer rack to the cassette 8.12 by the arm. A non-processed wafer C is drawn from the cassette 8.12 by the arm, aligned by the pre-aligner 11.5, and transferred to the wafer rack 9.11 of the loading chamber 9.2.

Thus, in the wafer rack 9.11, the processed wafer A can be replaced with the non-processed wafer C during the processing of the wafer B. Depending on the way of use of this inspecting and evaluating device, a plurality of stages 8.6 may be arranged in parallel. A wafer is transferred from a wafer rack 9.11 to each stage. In this way, several wafers can be simultaneously processed.

The above embodiment can achieve the following effects.

(1) It is possible to obtain the whole structure of the inspection system in the electron beam image projection method and process an object to be inspected at a high throughput.

(2) It is possible to protect an object to be inspected from dust while circulating a clean gas on the object within the mini environment space. By providing a sensor for monitoring the cleanliness, dust within the space can be monitored. It can inspect the object while providing these functions.

(3) The loading chamber and the working chamber are integrated. Since they are supported by the vibration isolating device, it is possible to transfer an object to be inspected to the stage without any external influence and to inspect the object accurately.

2-3) Electron Optical System

2-3-1) Outline

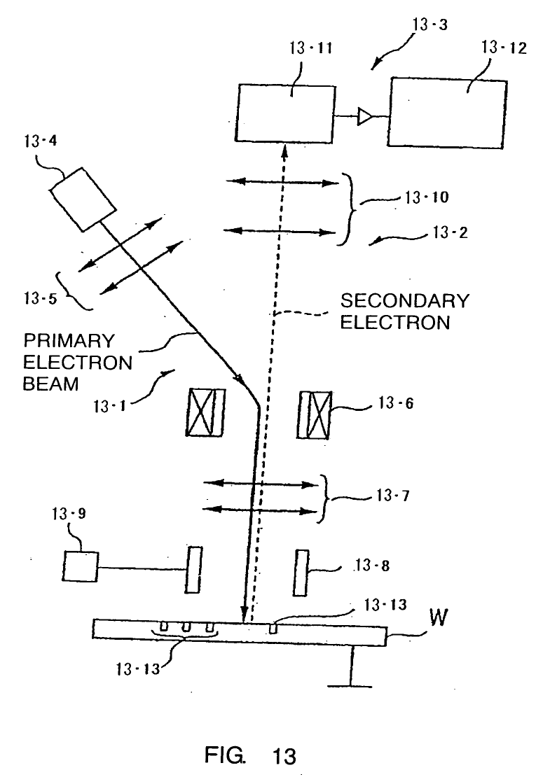

The electron optical system 8.8 includes the electron optical system and the detection system 13.3. The electron optical system is provided in a lens column 8.38 fixed to the housing main body 8.17. The electron optical system comprises a primary electron optical system (hereinafter, referred to as a primary optical system) 13.1 and a secondary electron optical system (hereinafter, referred to as a secondary optical system) 13.2. These are schematically illustrated in FIG. 13.

The primary optical system 13.1 is an optical system for irradiating the surface of a wafer W, that is, an object to be inspected, with electron beams. The primary optical system 13.1 comprises an electron gun 13.4 for emitting electron beams, a lens system 13.5 formed by an electrostatic lens for focusing the primary electron beam emitted from the electron gun 13.4, a Wien filter, that is E×B separator 13.6, and an objective lens 13.7. They are arranged in the sequence as shown in FIG. 13. The electron gun 13.4 is arranged at the top portion. In this embodiment, a lens forming the objective lens system 13.7 is a decelerating electrostatic objective lens. In this embodiment, the optical axis of the primary electron beam emitted from the electron gun 13.4 is inclined toward the illumination optical axis. The illumination optical axis is the optical axis of the electron beam with which the wafer W that is the inspection object is irradiated. The above axis is perpendicular to the surface of the wafer. An electrode 13.8 is arranged between the objective lens system 13.7 and the wafer W that is the inspection object. This electrode 13.8 has a shape symmetric with respect to the illumination optical axis of the primary electron beam. Voltage of the electrode 13.8 is controlled by the power source 13.9.

The secondary optical system 13.2 includes a lens system 13.10. The lens system 13.10 is formed by an electrostatic lens which passes secondary electron separated from the primary optical system through the E×B defector 13.6. The lens system 13.10 serves as a magnifying lens for magnifying the secondary electron image.

The detection system 13.3 comprises a detector 13.11 and an image processor 13.12. The detector 13.11 is disposed above the imaging surface of the lens system 13.10.

The incident direction of the primary beam is usually in the E direction of E×B filter (inverse direction to the electric field). This direction is the same as the integrating direction of the integrated line sensor (TDI: time delay integration). The integrating direction of the TDI may be different from the primary beam direction.

Hereinafter, the embodiment will be concretely described.

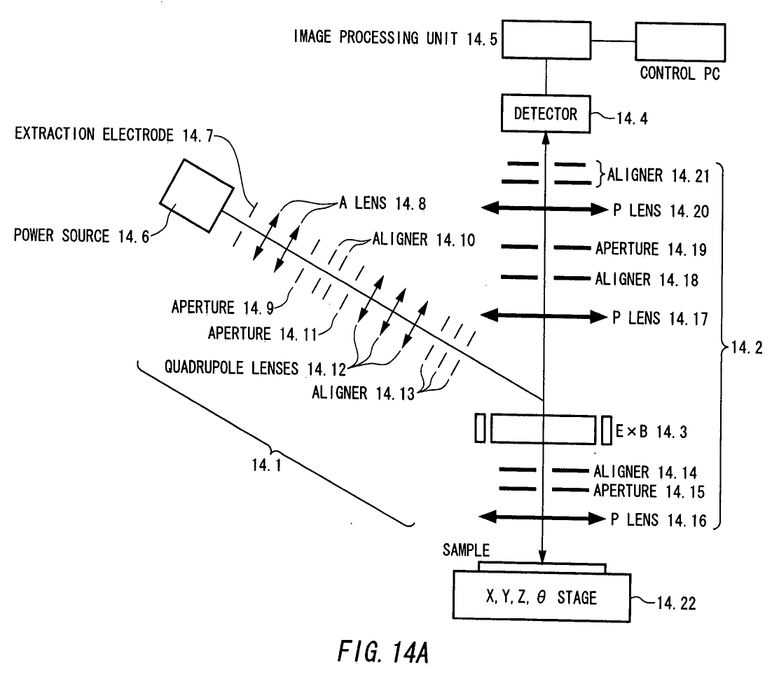

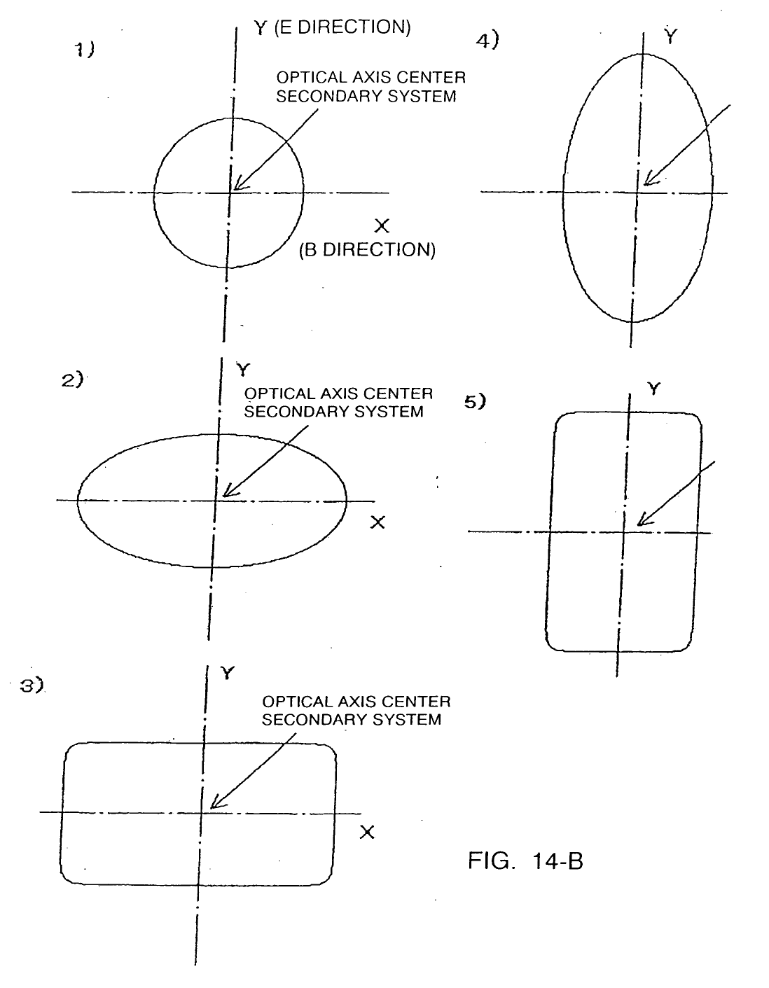

One example of the inspection device mainly comprises a vacuum chamber, a vacuum discharge system, a primary optical system, a secondary optical system, detector, an image processor, and a computer for their controls. FIG. 14A shows an example of the inspecting device.

It is provided with a primary optical system 14.1 and a secondary optical system 14.2. The primary optical system 14.1 irradiates a sample with electron beams. The secondary optical system 14.2 introduces the electron emitted from the sample surface to the detector. The emitted electron includes, for example, secondary electron, reflected electron, back scattered electron, and the like. The secondary optical system is a image projective optical system. A beam separator 14.3 (E×B) is used in order to separate the primary system and the secondary system. The image signal of the electron detected by the detector 14.4 is converted into an optical signal and/or an electric signal. This signal is processed by the image processor 14.5. At this time, the number of electrons incident to the detector may be 200 and less in an area corresponding to one pixel. A satisfactory image can be formed also in this case. Needless to say, also when the number of electrons in every one pixel area is 200 and more, an image can be satisfactorily formed.

The electron gun 14.6 that is the component of the primary optical system uses LₐB₆ as a hot filament. Electrons are extracted from a cathode in Wehnelt and extraction electrode 14.7. Thereafter, the beam converges on an aperture 14.9 through a two-stepped A lens (Einzel lens) 14.8 and crossover is formed. Thereafter, the beam passes through two stepped aligners 14.10, the aperture 14.11, three-stepped quadrupole lens 14.12, and three-stepped aligner 14.13. The beam is incident to the beam separator and deflected into the direction of the sample surface. The beam passes through the aligner 14.14, the aperture 14.15, and the P lens (objective lens) 14.16 of the secondary optical system. The beam is incident on the sample surface substantially vertically.

The aperture 14.9 ensures the uniformity on crossover and helps the beam to pass through the beam region of high brightness. The aperture 14.11 defines the beam incident angle toward the quadrupole lenses. The aligners (deflector) 14.10 are used to adjust the beam to be incident on the aperture 14.11 and the center of the optical axis of the quadrupole lenses 14.12. The quadrupole lenses 14.12 change the two directions of the beam, for example, the orbits of the X and Y directions. The quadrupole lenses 14.12 are used to transform the shape of the beam. In the shape of the sample illumination beam, for example, the quadrupole lenses 14.12 can transform the shape of the beam into circle, ellipse, and rectangle. These lenses can change the ratio of the shape of rectangle or ellipse in the X direction and in the Y direction (refer to FIG. 14B). After passing through the quadrupole lenses, the beam is adjusted by the aligner 14.14 to pass through the aperture 14.15 and the center of the P lens (objective lens) 14.16. The beam is thus incident on the sample surface. At this time, the illumination beam has a shape symmetric with respect to at least one of the two axes. The beam shape may be asymmetrical. Energy of the beam incident on the sample surface is finally determined by the voltage difference between the cathode and the sample surface. For example, when the cathode is 5.0 kV and the sample surface is −4 kV, the illumination beam energy becomes 1 keV (refer to FIG. 14A).

In this case, a difference of the voltage is ±10 V and a difference of the energy is ±20 eV. When the detected electrons are the secondary electrons and the beam illumination energy is 1.5 keV±10 eV to 5 keV±10 eV, the sample becomes negatively charged. In this state, the secondary electrons are emitted from the sample. The secondary electrons are magnified and imaged by the secondary system and introduced to the detection system. When the illumination energy is 50±10 eV to 1500 eV±10 eV, the sample surface becomes positively charged. The emitted secondary electrons are introduced to the detection system. The operation is less damaged in the positively charged state. The positively charged state, however, is easily affected by charge-up or by the uneven potential on the surface caused by charge-up. The negatively charged state can easily obtain stable image. The negatively charged state can diminish the influence by charge-up or distortion of image by the uneven potential on the surface caused by charge-up, compared with the positively charged state.

In the site of the aperture 14.15, each position of crossover in the secondary system and the primary system may be deviated from each other. For example, the secondary system forms the crossover of the secondary electrons on its center of the optical axis. The crossover of the first system is formed at the position (in the X direction or in the Y direction) deviated by 50 to 500 μm from the center of the optical axis of the secondary system. Thus, in the aperture 14.15, two crossovers in the primary system and the secondary system are not overlapped with each other. Thus, it is possible to loosen the current density and also possible to restrain blur from enlarging according to the space charge effect in the case of a large amount of beam current. This is effective, for example, when the current density of the primary system illumination beam is 1×10⁻³A/m² and more. When the current density is lower than this, it is not affected so much even when the centers of the optical axes of the both systems are identical.

One and more types of the secondary electrons, the reflected electrons, and the back scattered electrons are used as the emitted electrons from the sample surface in this embodiment. The discharge energy from the sample surface is, for example, as follows. Namely, when the incident beam energy is 1000 eV±10 eV, the respective energies of the secondary electron, the reflected electron, and the back scattered electron are about 0 to 10 eV, about 1000 eV±10 eV, and about 10 to 1000 eV.

Instead of the electron beam, focus ion beam (FIB) may be used. As the FIB source, Ga ion source of liquid metal is generally used. Another ion source of liquid metal using liquescent metal may be used. Alternatively, ion source of different method may be used. For example, duoplasmatron using discharge may be used.

The size of a sample is, for example, a chip of about 10×10 mm to 2, 4, 6, 8, 12 inch-wafer. Various kinds of samples may be used. The embodiment, in particular, is effective in detecting a defect of a wiring pattern having the line width of 100 nm and less, detecting a defect of a via having the diameter 100 nm and less, and detecting dust. This embodiment is effective in detecting these electrical defects. A sample includes a Si wafer, a semiconductor device wafer with some process added to Si, a micro-machined wafer, a substrate for liquid crystal display, and a wafer for hard disk head.

The secondary optical system 14.2 is the image projective optical system in the example of this embodiment. The secondary optical system 14.2 introduces the emitted electrons from the sample to the detection system where the emitted electrons are imaged with magnifying power. The emitted electrons include, for example, the secondary electrons, the reflected electrons, and the back scattered electrons as mentioned above. In the example of the lens structure in the column, the secondary optical system 14.2 is formed by the P lens (objective lens) 14.16, the aperture 14.15, the aligner 14.14, the beam separator 14.3, the P lens (intermediate lens) 14.17, the aligner 14.18, the aperture 14.19, the P lens (projective lens) 14.20, the aligner 14.21, and the micro channel plate (MCP) unit. In the upper flange in the column, a hermetic quartz glass is arranged. A relay lens and two dimensional charge coupled device (2D-CCD) are arranged above the glass. An image is formed on the fluorescent screen and caught by the 2D-CCD sensor.

The emitted electrons from the sample surface pass through the P lens (objective lens) 14.16, to the aperture 14.15 where the crossover is formed, and they are imaged on the center of the beam separator 14.3. When such a condition is established that the emitted electrons are imaged on the center of the beam separator, it is possible to restrain the influence caused by convergence of the secondary beam occurring in the beam separator 14.3. Therefore, this condition is effective. As for this point, for example, when the beam passes through the E×B, deflection amount and aberration differ depending on the height of image. By imaging the emitted electrons on the E×B, the aberration in the imaging component can be restrained at the minimum. It is the same situation as in the primary system. Also in the primary system, not only an image is formed on the sample, but also the image is formed in the vicinity around the beam separator. This reduces the aberration of the primary beam and restrains the unevenness of the current density on the sample advantageously.

The aligner 14.14 adjusts the beam to be at the center of its upper P lens (intermediate lens) 14.17. The aligner 14.18 adjusts the beam to be at the center of its upper P lens (projective lens) 14.20. The aligner 14.21 adjusts the beam to be at the center of its upper MCP. The magnification of the P lens (objective lens) 14.16 is 1.5 to 3, and the magnification of the P lens (intermediate lens) 14.17 is 1.5 to 3, and the magnification of the P lens (projective lens) 14.20 is 30 to 50. In order to achieve these magnifications, a voltage depending on each magnification is applied to each lens to adjust each magnification. In order to do a fine adjustment of focus, a focus correcting lens for the exclusive use is built in the P lens (objective lens) system. Through a fine adjustment of the voltage to be applied to the electrode, a focus can be adjusted. Crossover is formed at the both positions of the aperture 14.15 and the aperture 14.19. In this case, the aperture 14.15 can be used for backlight cut and the aperture 14.19 can be used to achieve the role of deciding the aberration and contrast.

For example, each size of the aperture 14.15 and the aperture 14.19 is in the range of φ30 μm to φ2000 μm inclusively, preferably it is in the range of φ30 μm to φ1000 μm inclusively, and more preferably it is in the range of φ30 μm to φ500 μm inclusively. When the aperture 14.15 chiefly determines the aberration, the transmittance, and the contrast characteristic, the aperture 14.15 is, for example, from φ30 μm to φ500 μm, and the aperture 14.19 is, for example, from φ1000 μm to φ2000 μm. When the aperture 14.19 chiefly determines the above, the aperture 14.19 is, for example, from φ30 μm to φ500 μm, and the aperture 14.15 is, for example, from φ1000 μm to φ2000 μm.

Stig electrodes may be arranged above and below the P lens (intermediate lens) 14.17. The stig electrode is used in order to correct astigmatism caused by the beam separator 14.3. The stig electrode is a stig formed by, for example, quadrupole, hexapole, and octupole electrodes. For example, different voltages are applied to the respective octupole electrodes. This can correct the astigmatism and spherical aberration.

The lens operation in the case of using the reflected electron and the back scattered electron will be described. In this case, as the P lens (projective lens) 14.20 of the final step, a decelerating lens (negative voltage apply lens) may be used. This lens is effective for noise cut of the secondary electrons. Generally, the amount of the secondary electrons is more than the amount of the reflected electrons. Its amount is ten to thousand times more than the amount of the reflected electrons. Therefore, when forming the beams into an image by using the reflected electrons and the back scattered electrons, in particular, the above lens becomes effective. For example, when the cathode voltage of the primary system power source is −4 kV and the potential of a sample is −3 kV, the energy of the reflected electron from the sample is 1 keV. When the voltage of the detector is at the ground level, a difference of energy between the reflected electron and the secondary electron is about 1 keV in the portion of the P electrode. The P lens (projective lens) electrode performs the operation of a negative voltage lens. At this time, such a condition of the central voltage can be used that permits the reflected electrons to pass and cut off the secondary electrons. The condition can be required through simulation.

The beam separator 14.3 is E×B with electric field and magnetic field crossing. Alternatively, the beam separator 14.3 may be a separator for separating the beams only in the magnetic field B. In the example of E×B, the beam separator 14.3 is formed by the E electrode forming a distribution of electric field and a magnetic pole having a surface orthogonal to it. The magnetic pole forms a distribution of magnetic flux density in the orthogonal direction. For example, the optical axis of the secondary system is perpendicular to the sample surface. The angle of the primary incident beam can be set at 10 to 90° with respect to the secondary axis. At this time, the primary beam is deflected by the E×B and incident to the sample surface vertically. The emitted electrons from the sample surface are introduced in the optical axis direction, namely in the direction vertical to the sample surface, by the E×B through the voltage applied to the E electrode and the magnetic flux density formed in the B magnetic pole. For example, a pair of E electrodes are at ±2 kV±1 V. A distribution of the magnetic flux density is formed in parallel with a pair of B magnetic poles. For example, at the center of the E×B, the magnetic flux density occurs in the direction of the magnetic pole 1 to 60 G±1G (refer to FIG. 14A).

The E×B can be applied to the case where there is an inverse relationship in deflection between the primary system and the secondary system. Specifically, the incident beam source of the primary system is provided right above a sample. The detector of the secondary system is provided on a path at 10 to 80° with respect to the axis of the primary system. The E×B doesn't add any deflection force to the beam of the primary system. The beam of the primary system is incident vertically to a sample. The E×B adds the deflection force to the beam emitted from the sample (secondary beam). In these ways, the emitted electrons can be introduced toward the detector.

In the detector 14.4, electrons are introduced into an electron intensifier tube such as MCP. Intensified electrons are emitted to the fluorescent surface and a fluorescent image is formed. The fluorescent surface is a side surface of a glass plate such as quartz glass. On the fluorescent surface, fluorescent material is coated. The fluorescent image is taken by the relay lens system and the two-dimensional CCD. The relay lens system and the two-dimensional CCD are provided in the upper column. In the upper flange in the column, a hermetic glass is provided, so as to separate the vacuum environment within the column from the outward atmospheric environment and to help decrease distortion of the fluorescent image and contrast deterioration. Thus, the fluorescent image can be efficiently taken by the CCD.

Instead of a CCD, an integrating line image sensor (TDI-CCD) camera may be used. In this case, a sample on the stage moves, for example, in a direction of the E electrode or a direction of the B magnetic pole. During the movement of a sample, the TDI can take its image. For example, assume that the number of integrating steps is 256 in the TDI, the number of pixels in every one step is 2048 (pixel number/step), the size of element is 15×15 μm, and the imaging magnification of the MCP to the sample surface is 300. In this case, when line/space is 0.1/0.1 μm, the size of the sample surface becomes 30/30 μm on the MCP surface. When the relay lens magnification is 1, the area 30 μm corresponds to the size of two elements. The position of the sample corresponding to one element corresponds to the sample size of 0.05×0.05 μm. During transfer on the stage, at the position of the sample corresponding to one element, the electrons corresponding to the 256 steps of elements are discharged. These discharged electrons are accumulated. The total amount of obtained electrons is increased in this way and an image is taken. This structure is effective especially when the stage speed is high. For example, it is much effective when the line rate is 100 kHz to 600 kHz. When the line rate is at a high speed, the number of the obtained electrons per one element is decreased. When the line rate is large, the intensity of the obtained beam per one element in the TDI sensor is decreased. By accumulating the electrons, however, the final intensity of the obtained beam becomes high. This can enhance the contrast and S/N. In short, the above structure has an advantage when the stage speed is high. The line rate is from 0.5 kHz to 100 MHz, preferably from 1 kHz to 50 MHz, and more preferably from 20 kHz to 10 MHz. In accordance with this line rate, the video rate (per one tap) is 1 to 120 MHz/tap, preferably 10 to 50 MHz/tap, and more preferably 10 to 40 MHz/tap. The number of taps is 1 to 520, preferably 4 to 256, and more preferably 32 to 128.

The CCD and the TDI sensor/camera are designed so as to have a characteristic of low noise and high sensitivity. For example, it can be set at 100 to 100000 DN/(nJ/cm²). It shows good efficiency at the setting of 1000 to 50000 DN/(nJ/cm²). Preferably, it should be set at 10000 to 50000 DN/(nJ/cm²). Therefore, even at a high line rate, it can obtain an image of high quality with a good S/N ratio.

When an image is obtained by using the CCD or the TDI sensor, the sensor region (pixel number×step number) may substantially conform with the illumination area of the primary beam. This situation is not only efficient but also it can decrease the noise. Some electrons may arrive at the detector from an upper portion excepting the area used for taking image. These electrons cause a noise. In order to decrease the noise, it is helpful that the beam to be incident to the portion other than the effective field of view should be reduced. The information of the image obtained by the CCD and the TDI sensor is converted into an electric signal. The data of the image information is processed by the image processor. Through this image processing, a comparison of the image is performed in the stages: Cell to Cell, Die to Die, and Die to Any Die, hence to do a defect inspection. For example, a defect of pattern, a defect of particle, and a defect of potential contrast are inspected. These defects mean a defective electrical connection of, for example, wiring and plating.

The stage 14.22 is formed by one of the X, Y, and Z transfer mechanisms or a combination of some of them.

The MCP has a function of amplifying an incident electron. The electrons emitted from the MCP are converted into light through the fluorescent plate. There is some case where the number of the incident electrons is so many that there is no need to multiply the number of electrons. In this case, there is no need to provide with the MCP. Instead of the fluorescent plate, scintillator can be used. A light signal (or image signal) is transmitted to the TDI, or an image is formed. When a relay lens is used, a predetermined magnification is given. When FOP is used, the magnification is one (light signal is transmitted in one-to-one). A photomultiplier tube amplifies the light signal and converts it into an electric signal. In a multi-photomultiplier tube, a plurality of photomultiplier tubes are arranged.

Image Processor

The image processor has a function of image comparison, defect detection, defect classification, image data recording, and the like.

In the above-mentioned electric beam inspection device, the shape of the primary illumination beam has to be symmetric to at least one axis of the X axis and the Y axis. The symmetrical beams around the optical axis are illuminated there. Then, an image can be formed on the electron incident surface of the detector with low aberration and low distortion.

When the CCD and the TDI are used as the detector, the proper amount of the incident electrons is as follows. Here, the amount of the electrons incident to the area corresponding to one pixel (for example, on the MCP) will be described. When the amount of the incident electrons is not more than 200/pixel area, a sufficient S/N ratio can be obtained. The image can be used for image processing and defect detection. From this viewpoint, for example, in the image projective optical system, the size of the aperture 14.15 or 14.19 is defined, thereby to have effects of cutting noise and reducing aberration. For example, an S/N ratio can be improved by providing the aperture of diameter 30 μm to 1000 μm. With the incident amount of 200 electrons/one pixel area, a high resolution and good image can be obtained.

The TDI integrates the number of pixels corresponding to the number of steps in a transfer direction of the stage. In the case of this embodiment, integration for 256 steps is performed. The proper number of integration steps is in the range of 114 to 8192 inclusively, preferably in the range of 114 to 4096 inclusively, and more preferably in the range of 512 to 4096 inclusively. Assume that in the integration direction, there is a little illumination nonuniformity in the primary beam and that there is a little nonuniformity in the signal electrodes from the sample. In this case, by the effect of the integration, the nonuniformity is averaged. The detected information on electrons becomes constant and stable information. Therefore, it is preferable that a direction where the illumination nonuniformity of the primary electron beam easily occurs should be taken into consideration when determining a transfer direction of the stage. Preferably, the stage transfer direction is determined so that the illumination nonuniformity easily occurring direction should agree with the integration direction of the TDI. Use of the TDI enables sequential image acquisition. Here, the CCP may be provided. When an image is obtained, the stage may be scanned in a Step-and-Repeat method.

The aspect on the sample surface is enlarged by the electrons and an image is formed on the detector. When the resolution of the image is set at about one pixel of the CCD or the TDI, it is preferable that the aberration and blur in the secondary optical system is within one pixel. When the signal electrons are deflected in the E×B, aberration and blur become larger. In the embodiment, the secondary optical system is set so as to advance the signal electrons directly without the E×B deflecting the signal electrons. The signal electrons include the secondary electrons, the reflected electrons, the back scattered electrons, and the like. Namely, in the structure of the embodiment, the central axis of the secondary optical system is a straight line and this straight line goes through the center of the scope of the sample, the center of the E×B, and the center of the detector.

When there is no blur in the image of the secondary optical system, any other structure than the above may be provided. It is needless to say that such structure is included in this invention.

2-4) Control System

The control system mainly comprises a main controller, an operation controller, and a stage controller. The main controller is provided with a man-machine interface. The operation of an operator is performed through the man-machine interface (various instructions/orders, recipe input, inspection start instruction, switching between automatic inspection mode and manual inspection mode, all necessary commands in the manual inspection mode, etc.). The main controller communicates with a host computer of a factory, so as to control the vacuum discharge system, to transfer and align a sample such as a wafer, to transmit a command to the other operation controller and stage controller, and receive the information from the above controllers. The controller has a function of obtaining an image signal from an optical microscope. The controller has a function of stage vibration correcting function. This correction function feeds back a variable signal of the stage to the electron optical system so as to correct the quality of the image. Further, the controller has an automatic focus correction function. The correcting function is to detect a displacement in the Z direction (axial direction of the secondary optical system) at the position of sample observation, to feed back the detection result to the electron optical system, and to correct the focus automatically. Transfer of a feed back signal to and from the electron optical system is performed through the operation controller. Transfer of a signal to and from the stage is performed through the stage controller.

The operation controller mainly performs the controls of the electron optical system. The controls of the electron optical system include, for example, the controls of the accurate power source for the electron gun, lens, aligner, Wein filter, and the like. More specifically, for example, when the magnification is changed, a constant current of electrons is emitted to the illumination area. For example, according to each magnification, each voltage to each lens system and aligner is automatically set. For example, according to each operation mode, similarly each voltage to the above is automatically set. The operation controller performs the controls (ganged control) as described in the above.

The stage controller mainly performs the control concerned with the transfer of the stage. The stage controller enables a fine transfer of the order of μm in the X direction and the Y direction. The accuracy of transfer is the order of μm. A transfer error is within ±5 μm, preferably within ±1 μm, and more preferably within ±0.5 μm. In this stage, a control in the rotation direction (θ control) is performed. An error in the rotation direction is within about ±10 seconds, preferably within ±1 second, and more preferably within ±0.3 seconds. Hereinafter, the structure of the control system will be concretely described.

2-4-1) Structure and Function

This device provides a function of imaging and displaying a specified position of a wafer with an electron microscope or an optical microscope, a function of imaging the above specified position with the electron microscope and detecting a defect and classifying the defect, and a function of imaging and displaying the above defect-detected position with the electron microscope or the optical microscope. In order to realize and maintain the above functions, the device comprises an electro optical system control function, a vacuum system control function, a wafer transfer control function, a component unit operation function, an imaging function, an automatic defect inspection function, a system error detection function, and a system activation/stop function.

The auxiliary functions are as follows.
(1) Electron Optical System Control Function
(a) Lens voltage control
(a-1) Ganged control
(a-2) Voltage application with application function
(a-3) Multipole lens cooperative voltage application
(a-4) Wobble control
(b) Electron beam output adjustment
(b-1) Pre-heat (Gun)
(b-2) Heat-up (Gun)
(b-3) Emission current control (BIAS control)
(2) Vacuum System Control Function
(a) Vacuum discharge/atmosphere release (separate chambers)
(b) Vacuum discharge/atmosphere release (one specified chamber)
(3) Wafer Transfer Control Function

Step operation/automatic operation of the following operations
(a) Wafer load
(b) Wafer unload
(4) Component Unit Operation Function
(5) Imaging Function

The following two input systems are selected, to pick up an image:
(a) CCD camera
   optical microscope at low magnification (pixel size: 2.75 μm/pix)
   optical microscope at high magnification (pixel size: 0.25 μm/pix)
(b) TDI camera
(b-1) TDI-still
(b-2) TDI-scan
   EB×80 (pixel size: 0.2 μm/pix)
   EB×160 (pixel size: 0.1 μm/pix)
   EB×320 (pixel size: 0.05 μm/pix)
   EB×480 (pixel size: 0.03 μm/pix)

Further, in order to prevent from accident caused by a wrong operation, a user mode specifying function is provided. The user mode specifying function is a function for restricting the operation-capable items depending on the technical level and the knowledge level of an operator. This user mode is specified by the user ID and password entered at the activation of GUI (Graphical User Interface).

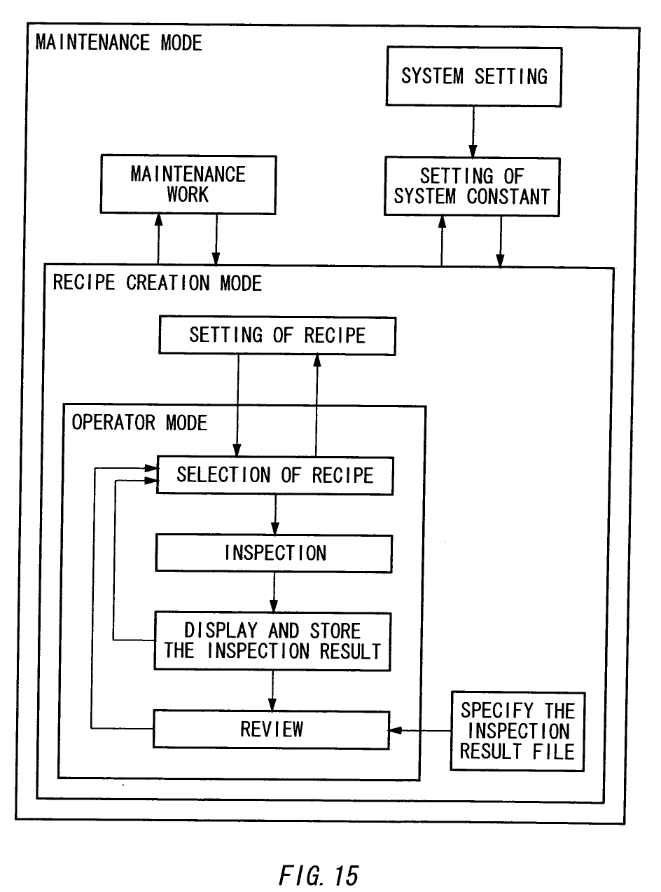

The user mode includes a maintenance mode, a recipe creating mode, and an operator mode. The operation in the maintenance mode is performed at a time of staring the device after the device is mounted and at a time of maintenance work. When a recipe is created, a recipe creation mode is set. A necessary operation and procedure are assisted. In the automatic defect inspection, the operator mode is set. By using the created recipe, an inspection is performed. FIG. 15 shows the relation between the respective user modes and the respective operation forms.

Maintenance mode . . . component unit operation, wafer transfer, vacuum system control, electron optical system control, observation (image pick-up with the optical microscope or TDI), defect inspection, review

Recipe creating mode . . . wafer transfer, observation (image pick-up with the optical microscope or TDI), defect inspection, review Operator mode . . . automatic defect inspection (automatic control of the necessary function such as wafer transfer), review

This device has the constant device number and a recipe defined. The constant device number and the recipe are variable parameters necessary for operation. The constant device number is a parameter for absorbing the inherent error of the device (like installation error). The recipe is a parameter for defining various kinds of conditions in order to perform the automatic defect inspection. The constant device number is set at the starting time and after the maintenance work. Basically, the constant device number is not changed thereafter.

The recipe is classified into a transfer recipe, an alignment recipe, a die map recipe, a focus map recipe, and an inspection recipe. According to these recipes, a defect inspection is performed. The setting work is performed before the inspection processing. Setting of a plurality of patterns is stored.

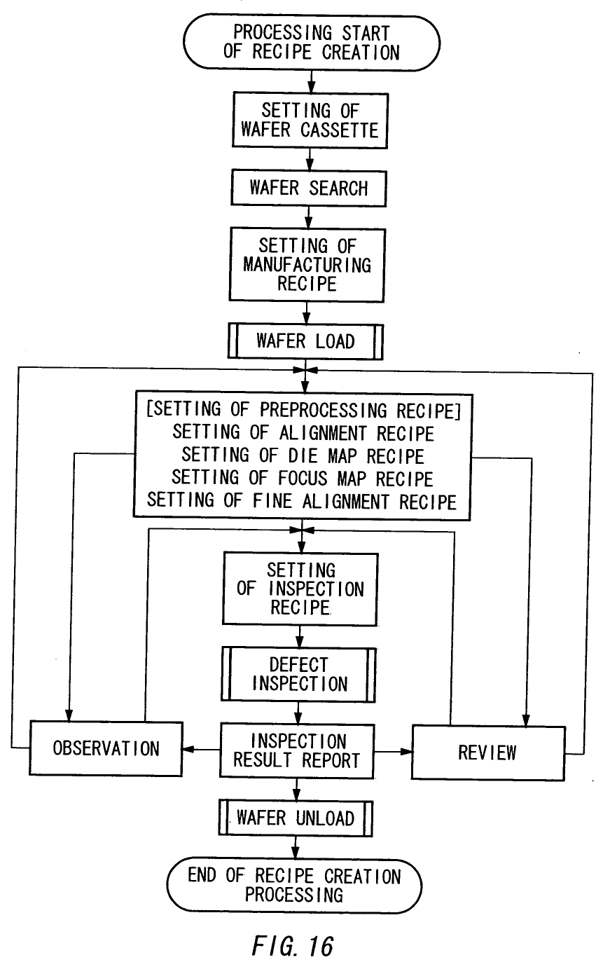

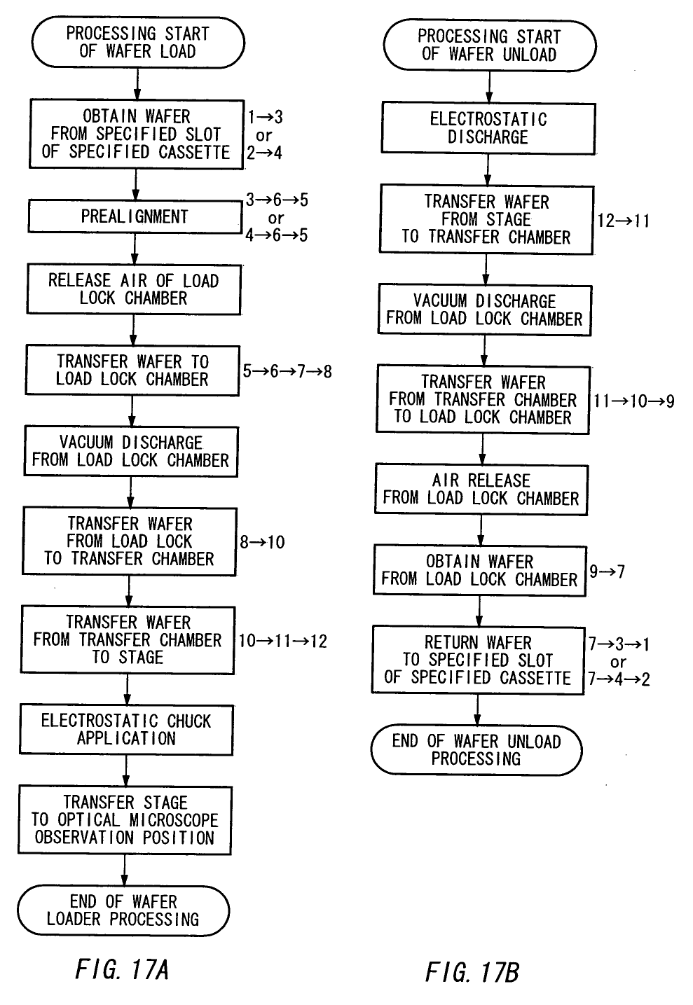

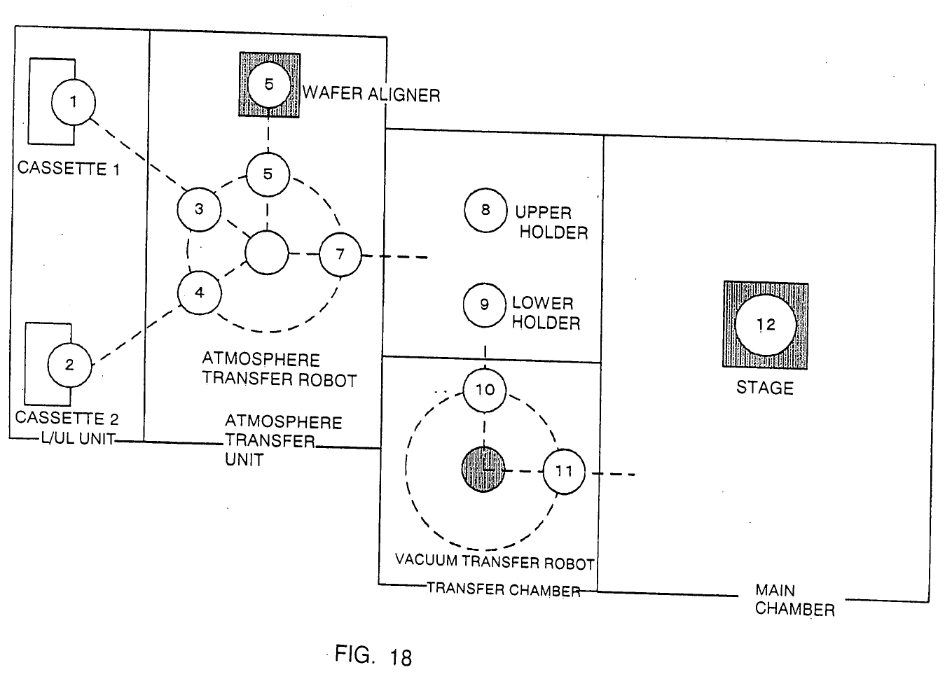

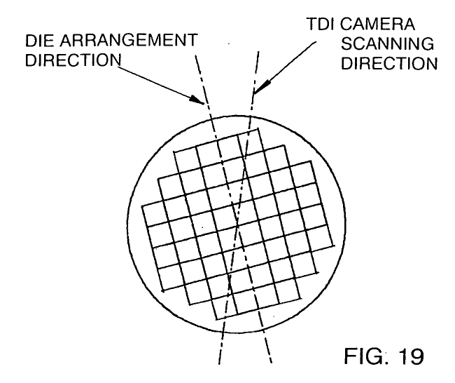

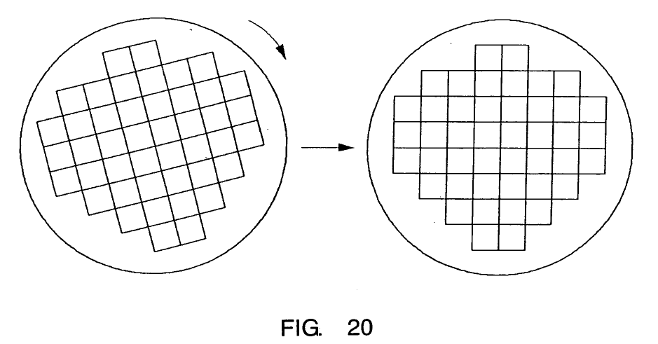

FIG. 16 shows the procedure at the time of creating a recipe. The first step is a step for transferring a wafer to the stage (wafer load). After the wafer cassette is mounted on the device, wafer search is performed. The wafer search detects the presence of a wafer of each slot within the cassette. Wafer size, type of notch/orientation-flat, and notch direction are specified as for the detected wafer. The notch direction is a direction when it is loaded on the stage. A wafer is loaded according to the procedure shown in FIG. 17A, FIG. 17B, and FIG. 18. These conditions are stored in the transfer recipe. The arrangement direction of die of a wafer loaded on the stage doesn't necessarily agree with the scan direction of the TDI camera (FIG. 19). In order to bring this into one accord, an operation of rotating a wafer at the θ stage is necessary. This operation is called alignment (FIG. 20). The alignment recipe stores the condition of performing alignment after a wafer is loaded on the stage.

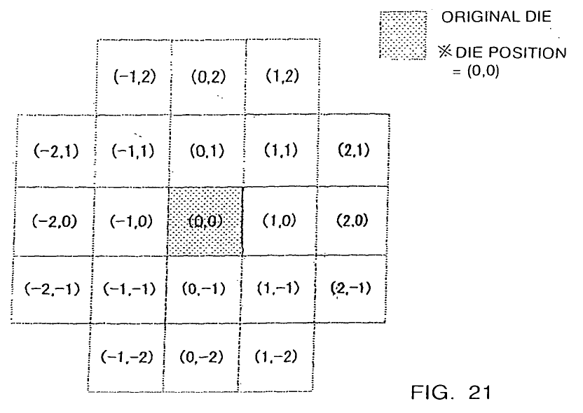

At the alignment time, a die map (FIG. 21) is created. The die map shows an array of dies. The die map recipe stores the size of a die and the position of the original die. The position of the original die becomes a starting point showing the position of each die.

2-4-2) Alignment Procedure

As the alignment (positioning) procedure, at first, a rough alignment is performed by using the low magnification of the optical microscope. Then, it is performed by using the high magnification of the optical microscope. At last, by using the EB image, detailed alignment is performed.

A. Optical Microscope Image Pick-Up at Low Magnification

(1) <First, Second, Third Search Die Specification and Template Specification>

(1-1) First Search Die Specification and Template Specification

The stage is moved according to the user's operation so as to position the left bottom corner of a die (lower portion of a wafer) near the center of the camera. After the positioning, a pattern matching template image is obtained. This die is a die as a reference for alignment. The coordinate of the left bottom corner becomes the coordinate of a feature point. Thereafter, this template image is used to do the pattern matching. Thus, the accurate positional coordinate of any die on a substrate can be measured. The template image is an image that will be a unique pattern within a search area. This image has to be selected as the template image.

In this embodiment, the left bottom corner is the position where a template image for pattern matching is obtained. This embodiment is not restricted to this. Any position within a die may be selected as a feature point. Generally, it is easier to specify the coordinate of a point in the corner than the coordinate of a point in a die or on its side. Therefore, it is preferable that one of the four corners is selected. Also, in the embodiment, a template image for pattern matching is obtained as for a die positioned in the bottom of a wafer. It is needless to say that any die may be selected for easy performance of alignment.

(1-2) Second search Die Specification

In the embodiment, a die rightward adjacent to the first search die is the second search die. The stage is moved according to the user's operation so that the left bottom corner of the second search die can be positioned near the center of the camera. After the positioning, pattern matching is automatically performed by using the template image obtained in the above (1-1). Thus, in the embodiment, the accurate coordinate of the pattern of the second search die is obtained which agrees with the template image specified by the first search die.

In the description of the embodiment, the die rightward adjacent to the first search die is the second search die. Needless to say, the second search die of the invention is not restricted to this. The coordinate of a feature point of a reference die is accurately caught. The positional relation of a die in a column direction according to the reference point is accurately caught through pattern matching. A point of the second search die may be selected so as to be able to catch this positional relation. Therefore, a die leftward adjacent to the first search die can be regarded as the second search die.

(1-3) Third Search Die Specification

A die upward adjacent to the second search die is the third search die. The stage is moved according to the user's operation so that the left bottom corner of the third search die can be positioned near the center of the camera. After the positioning, pattern matching is automatically performed by using the template image obtained in the above (1-1). Thus, in the embodiment, the accurate cooperation of the pattern of the third search die is obtained which agrees with the template image specified by the first search die.

In the description of the embodiment, the die upward adjacent to the second search die is the third search die. Needless to say, the third search die of the invention is not restricted to this. The coordinate of the feature point of a die is accurately caught and this die becomes a reference, in this embodiment. The positional relation of a die in a row direction has to be accurately caught. The positional relation includes a distance of the coordinate of a specified point. Therefore, a die upward adjacent to the first search die can be preferably used instead.

(2) <Pattern Matching in Y Direction with Optical Microscope at Low Magnification>

(2-1) The shift amount (dX, dY) toward the pattern of the upper adjacent die is calculated according to the relation between the pattern matching coordinate (X2, Y2) of the second search die and the pattern matching coordinate (X3, Y3) of the third search die.
dX=X3−X2
dY=Y3−Y2

(2-2) The stage is moved to the coordinate where there exists (supposed to exist) the pattern of a die upward adjacent to the first search die, by using the calculated shift amount (dX, dY). This coordinate is (XN, YN).
XN=X1+dX
YN=Y1+dY
*(X1, Y1): the coordinate of a pattern of the first search die

(2-3) After the shift of the stage, an image is picked up at low magnification of the optical microscope. Pattern matching is performed by using the template image. The accurate coordinate value (XN, YN) of the pattern during observation is obtained. The initial value of the detected number of dies (DN) is set at 1.

(2-4) The shift amount (dX, dY) is calculated. The shift amount (dX, dY) is a shift amount from the pattern coordinate (X1, Y1) of the first search die to the coordinate (XN, YN) of the pattern under currently imaging.
dX=XN−X1
dY=YN−Y1

(2-5) The stage is moved for the double shift amount (2*dX, 2*dY) of the calculated shift amount (dX, dY) with the first search die as a starting point.

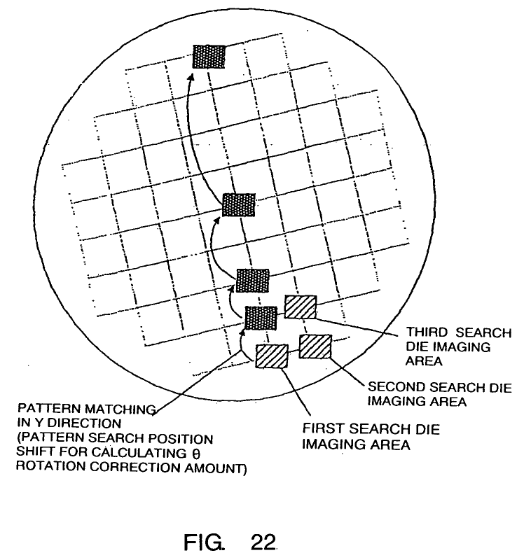

(2-6) After the shift of the stage, an image is picked up by the optical microscope at low magnification. Pattern matching is performed by using the template image. The accurate coordinate (XN, YN) of the pattern under observation is updated. The number of the detected dies is doubled (refer to FIG. 22).

(2-7) The operations of (2-4) to (2-6) will be repeated toward the upper portion of a wafer until exceeding the predetermined Y coordinate value.

In the description of the embodiment, the processing has been repeated with the double shift amount. This can enhance the accuracy. Further, this can also reduce the number of processing (number of repetition) and shorten the processing time. When the accuracy is satisfactory and a further decrease in the processing time is wanted, the shift amount may be large. The processing may be performed with integral times of shift amount larger than twice, like three times or four times. On the contrary, if there is no problem, in order to enhance the accuracy further, shift may be repeated with a fixed shift amount. In any case, the detected number reflects the shift amount.

(3) <θ Rotation with Optical Microscope at Low Magnification>

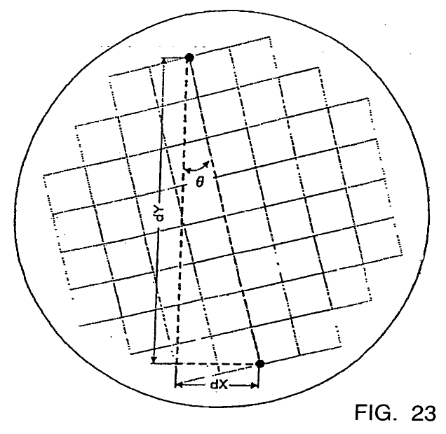

(3-1) The rotation amount (θ) and the die size in the Y direction (YD) are calculated. The calculation processing uses the shift amount from the pattern coordinate (X1, Y1) of the first search die to the accurate coordinate (XN, YN) of the pattern of the last searched die and the number of the dies having been detected (DN) (refer to FIG. 23).
dX=XN−X1
dY=YN−Y1
θ=tan⁻¹(dX/dY)
YD=sqrt((dX)²+(dY)²)/DN
*sqrt(A)=√A

(3-2) The θ stage is rotated by the calculated rotation amount (θ).

B. Optical Microscope Image Pick-Up at High Magnification

(1) The same procedure as (1) of the optical microscope at low magnification is performed by using the optical microscope at high magnification.

(2) The same procedure as (2) of the optical microscope at low magnification is performed by using the optical microscope at high magnification.

(3) The same procedure as (3) of the optical microscope at low magnification is performed.

(4) <Check of Tolerance after θ Rotation with Optical Microscope at High Magnification>

(4-1) “Specify the first search die and the template of the optical microscope high magnification”

The coordinate (X′1, Y′1) of the first search die after rotation is calculated from the coordinate before rotation (X1, Y1) and the rotation amount (θ). The stage is moved to the coordinate (X′1, Y′1). After the positioning, the template image for pattern matching is obtained.
X′1=x₁*cos θ−y₁*sin θ
Y′1=x₁*sin θ+y₁*cos θ

(4-2) Pattern Matching in the Y Direction with Optical Microscope at High Magnification

The stage is moved from the coordinate (X′1, Y′1) of the first search die after rotation by dY in the Y direction. By performing the pattern matching, the accurate coordinate (XN, YN) of the pattern under observation is obtained.

(4-3) The shift amount (dX, dY) is calculated. The shift amount (dX, dY) means a shift amount from the coordinate (X′1, Y′1) of the first search die after rotation to the coordinate (XN, YN) of the pattern under observation.
dX=XN−X′1
dY=YN−Y′1

(4-4) The stage is moved by the double shift amount (2*dX, 2*dY) of the calculated shift amount (dX, dY) with the first search die as a starting point.

(4-5) An image is picked up by the optical microscope at high magnification after the stage is moved. The pattern matching is performed by using the template image. The accurate coordinate (XN, YN) of the pattern under observation is updated.

(4-6) The operations (4-3) to (4-5) will be repeated toward the upper portion of a wafer until exceeding a predetermined Y coordinate.

(4-7) Calculation of the Rotation Amount of θ

The rotation amount (θ) is calculated. The calculation processing uses a shift amount from the coordinate (X′1, Y′1) of the first search die after rotation to the accurate coordinate (XN, YN) of the pattern of a die last searched.
dX=XN−X1
dY=YN−Y1
θ=tan⁻¹(dX/dY)

(4-8) Check of Tolerance θ with Optical Microscope at High Magnification

In this processing, it is confirmed that the rotation amount (θ) calculated in the above (4-7) is not more than the predetermined value. When the rotation amount exceeds the predetermined value, the above (4-1) to (4-8) will be performed again after the θ stage is rotated by using the calculated rotation amount (θ). When the rotation amount doesn't come in a tolerance level even after the predetermined times of repetition of the above (4-1) to (4-8), the processing will be supposed to be error and cancelled.

C. Alignment with EB Image

(1) <Specification of First Die for Y Search and EB Template>

The same procedure as (1) of the optical microscope at high magnification is performed by using the EB image.

(2) <EB Y Direction Pattern Matching>

The same procedure as (2) of the optical microscope at high magnification is performed by using the EB image.

(3) <EB θ Rotation>

The same procedure as (3) of the optical microscope at high magnification is performed by using the EB image.

(4) <EB Tolerance Check after θ Rotation>

The same procedure as (4) of the optical microscope at high magnification is performed by using the EB image.

Depending on necessity, the above (1) to (4) will be performed by using the EB image of high magnification.

The schematic value of the die size in the X direction (XD) is calculated from the coordinate (X1, Y1) of the first search die and the coordinate (X2, Y2) of the second search die.
dX=X2−X1
dY=Y2−Y1
XD=sqrt((dX)²+(dY)²)
*sqrt(A)=√A

D. Creation of Die Mapping Recipe

(1) <Specification of First Die for X Search and EB Template>

The stage is moved according to the user's operation so that the left bottom corner of a die positioned at the left edge of a wafer can be positioned near the center of the TDI camera. After the positioning, the template image for pattern matching is obtained. This template image is an image that will be a unique pattern within the search area. This image has to be selected as the template image.

(2) <EB X Direction Pattern Matching>

(2-1) The stage is moved to the coordinate where there exists (supposed to exist) a pattern of a die rightward adjacent to the first die for X search, by using the schematic value of the die size in the X direction. This coordinate is (X1+XD, Y1).

(2-2) The EB image is picked up by the TDI camera after the stage is moved. Pattern matching is performed by using the template image. The accurate coordinate (XN, YN) of the pattern under observation is obtained. The initial value of the detected number (DN) of dies is set at one.

(2-3) The shift amount (dX, dY) is calculated. The shift amount (dX, dY) means a shift amount from the pattern coordinate (X1, Y1) of the first die for X search to the coordinate (XN, YN) of the pattern under observation.
dX=XN−X1
dY=YN−Y1

(2-4) The stage is moved by the double shift amount (2*dX, 2*dY) of the calculated shift amount (dX, dY) with the first die for X search as a starting point.

(2-5) After the stage is moved, the EB image is picked up by the TDI camera. Pattern matching is performed by using the template image. The accurate coordinate (XN, YN) of the pattern under observation is updated. The number of the detected dies is doubled.

(2-6) The above (2-3) to (2-5) will be repeated in the right direction of a wafer until exceeding a predetermined X coordinate.

(3) <Calculation of Inclination in X Direction>

Stage direct drive error (φ) and the die size in the X direction (XD) are calculated. The calculation processing uses the shift amount from the pattern coordinate (X1, Y1) of the first die for X search to the accurate coordinate (XN, YN) of the pattern of the last searched die and the number of the dies having been detected so far (DN).
dX=XN−X1
dY=YN−Y1
φ=tan⁻¹(dY/dX)
XD=sqrt((dX)²+(dY)²)/DN
*sqrt(A)=√A

(4) <Creation of Die Map>

Thus, the die size in the X direction (XD) is required. When the rotation amount (θ) is previously calculated, the die size in the Y direction (YD) has been required. By combination of the die size in the X direction (XD) and the die size in the Y direction (YD), a die map (ideal arrangement information of dies) is created. By using the die map, the ideal arrangement of dies is found. While, the dies on the actual substrate are affected by, for example, a mechanical error of the stage (error of parts such as guide and assembling error), an error of interferometer (caused by some trouble of assembling a mirror and the like), and distortion of an image at a charge-up. It is not always possible to observe the dies in the ideal arrangement. Therefore, it is important to understand a difference between the actual position of the dies and their ideal arrangement on the die map and the difference is specified. Taking this difference into consideration, an inspection will be performed while automatically correcting the difference.

E. Procedure of Creating Focus Recipe

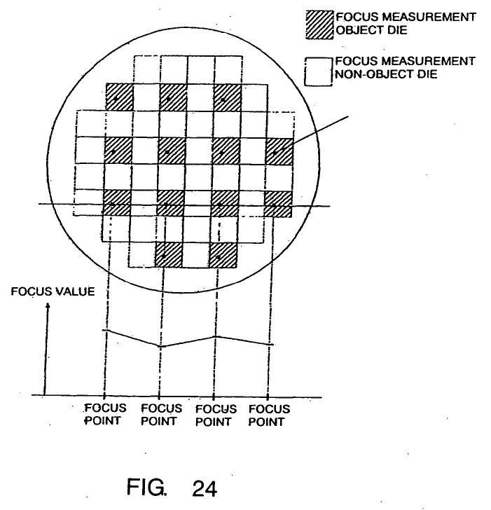

The procedure of creating a focus recipe will be described this time. A focus recipe stores the optimum focus position at a marked position on the plain surface of a sample such as a substrate. Alternatively, a focus recipe stores the information of various conditions about the focus position. The focus recipe has a predetermined form such as a table. In the focus recipe, focus conditions are set only at a specified position on a wafer. The focus value between the specified positions is obtained by linear interpolation (refer to FIG. 24). The procedure of creating a focus recipe is as follows.

(1) A focus measured die is elected from the die map.

(2) A focus measuring point is set within a die.

(3) The stage is moved to each measuring point. The focus value (CL12 voltage) is manually adjusted based on the image and the contract value.

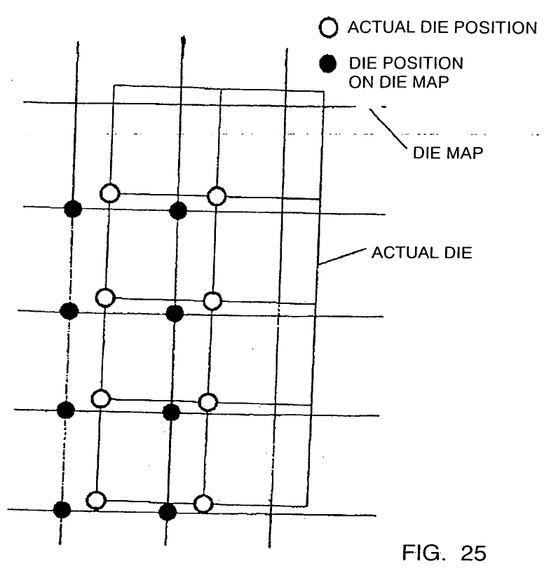

A die map has been created in the above alignment processing. The die map is the ideal positional information calculated from the die coordinates of the both ends of a wafer. For various factors, there occurs a difference between the die position on the die map and the actual die position (refer to FIG. 25). A parameter is created for absorbing this difference. The procedure of creating this parameter is called fine alignment. A fine alignment recipe stores the information of a difference between the position on the die map (information of the ideal die arrangement) and the actual die position. The information set here is used for inspecting a defect. In the fine alignment recipe, a difference is measured only on a die specified on the die map. A difference between the specified dies is obtained by linear interpolation.

F. Fine Alignment Procedure

(1) An object die of difference measurement for fine alignment is specified from the die map.

(2) A reference die is selected from the above object dies of difference measurement. The position of this die is specified as a point zero having no difference from the die map.

(3) The left bottom corner of the reference die is picked up by the TDI camera. The template image for pattern matching is obtained.

* A unique pattern within the search area is selected as the template image.

(4) The coordinate (X0, Y0) (on the die map) in the left bottom of the neighboring object die of difference measurement is obtained and the stage is moved. After the movement, an image is picked up by the TDI camera, and pattern matching is performed by using the template image of (3). The accurate coordinate (X, Y) is obtained.

A difference between the coordinate (X, Y) obtained through the pattern matching and the coordinate (X0, Y0) on the die map is stored.

(6) As for all the object dies of difference measurement, the above (4) and (5) will be performed.

2-4-3) Defect Inspection

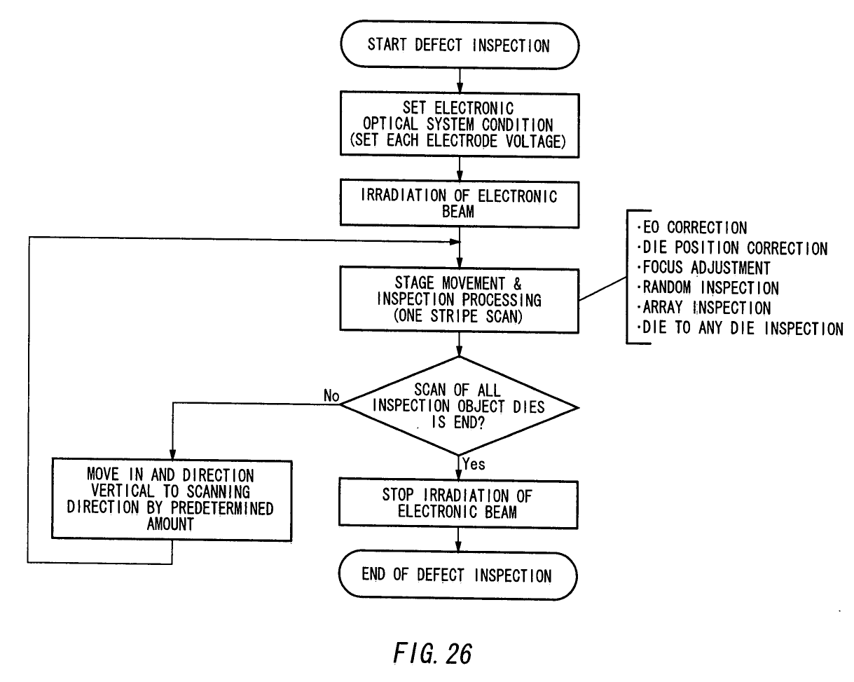

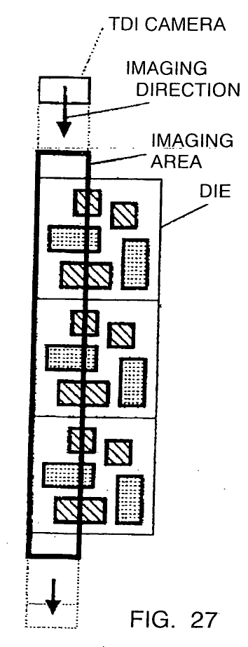

A defect inspection requires the setting of conditions of the electron optical system (setting such as magnification and the like), as illustrated in FIG. 26. The stage is moved under irradiation of electron beams. Thus, the TDI scanner picks up an image (FIG. 27). The inspection processing unit for exclusive use (IPE) inspects a defect at real time according to the set inspection condition (array inspection condition, random inspection condition, and inspecting area).

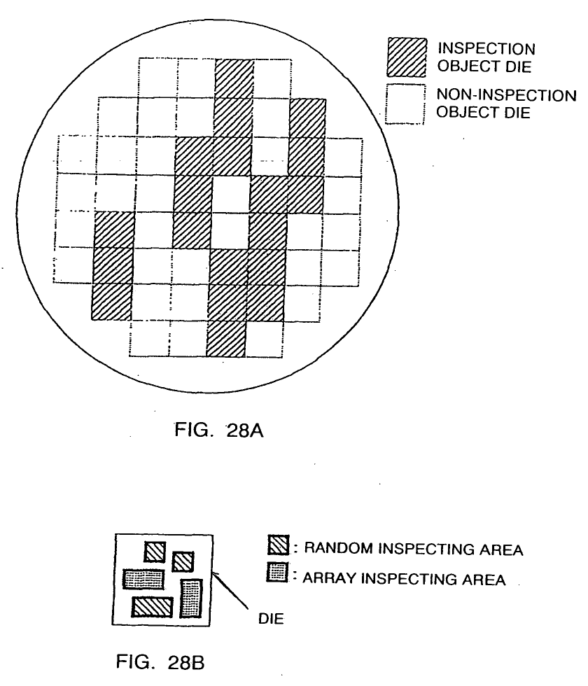

The inspection recipe requires the setting of the condition of the electron optical system, a die to be inspected, an inspecting area, and an inspection method (random/array) (FIG. 28A, FIG. 28B).

In order to obtain a stable image for the defect inspection, EO correction, correction of the die position, and the focus adjustment are simultaneously performed at real time. In the EO correction, blurring of the pick-up image caused by the positional deviation and the uneven speed is restrained. The correction of the die position absorbs a difference between the position on the ideal die map and the actual die position. The focus adjustment interpolates the focus value on the whole area of a wafer by using the pre-measured focus value at limited measuring points.

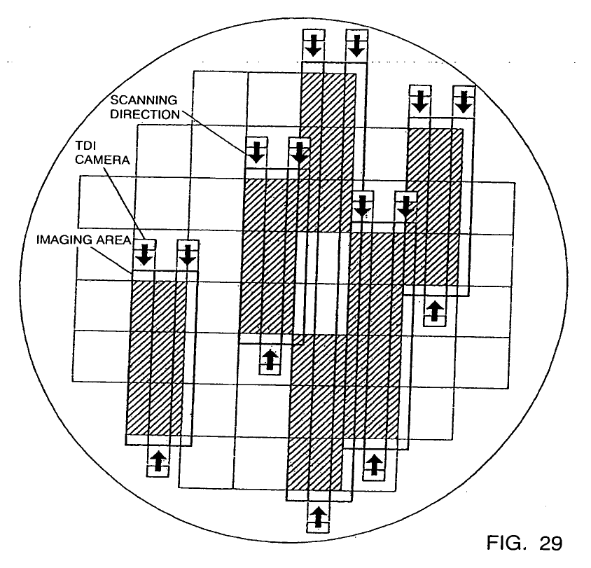

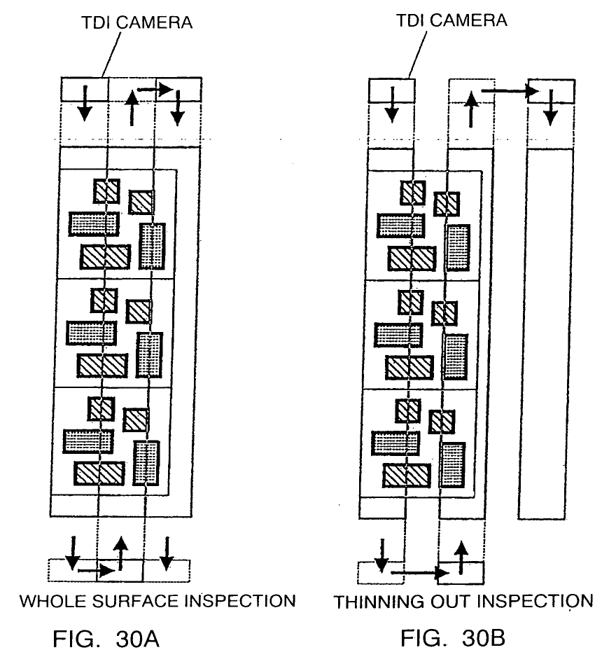

According to the scanning operation of the defect inspection, the whole area of the object die is inspected (FIG. 29). As illustrated in FIG. 30A and FIG. 30B, the shift amount toward the direction orthogonal to the scanning direction may be adjusted. Here, a thinning-out inspection is possible. The thinning-out inspection can shorten the inspection time, but in this simple thinning-out inspection, an area subject to the inspection is not necessarily an important area on the inspection. An particularly important and critical area on the inspection may be selected. Any of the above area can be arbitrarily selected and inspected. Thanks to this, the inspection time can be shortened and the inspection can be correctly performed on the important area. Therefore, accuracy can be efficiently assured.

After the inspection, the inspection result is displayed on a display. The inspection result includes the number of defects, the position of a die including a defect, defect size, the position of a defect within each die, the type of a defect, a defect image, and a comparison image. The information and the recipe information are stored in a file. Therefore, the past inspection result can be confirmed and reproduced.

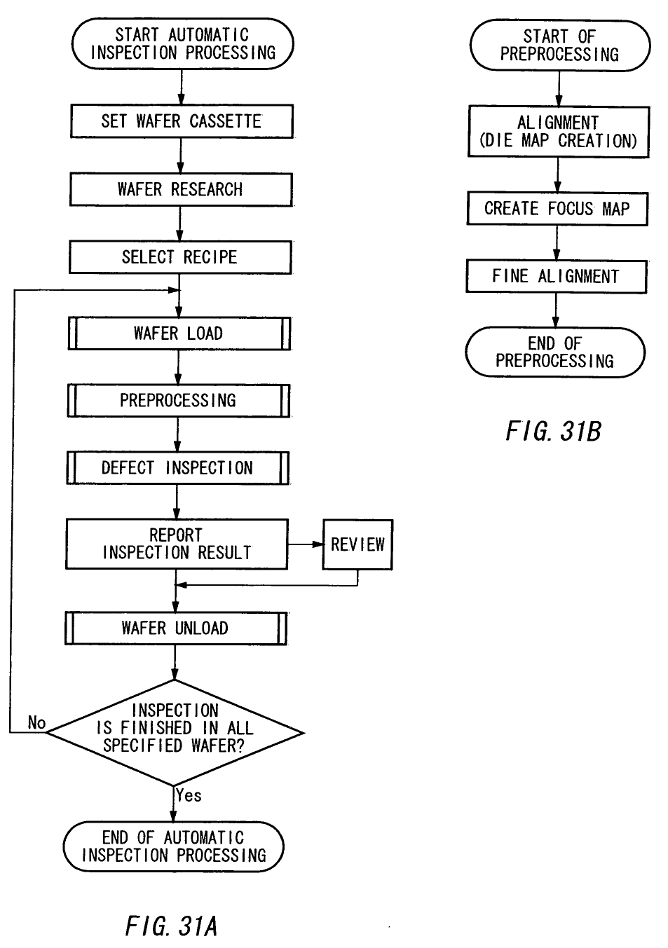

At the automatic defect inspection, various kinds of recipes will be selected and specified. According to the transfer recipe, a wafer is loaded, according to the alignment recipe, a wafer is aligned on the stage, according to the focus map recipe, the focus condition is set, according to the inspection recipe, inspection is performed, and according to the transfer recipe, a wafer is unloaded (FIG. 31A and FIG. 31B).

2-4-4) Structure of Control System

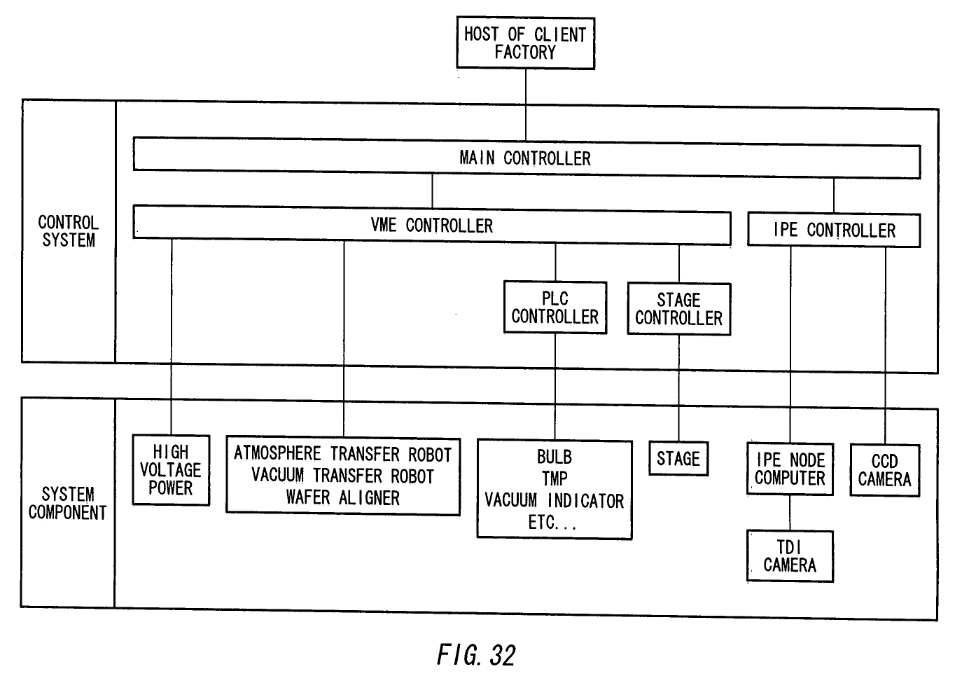

This system comprises a plurality of controllers as illustrated in FIG. 32. The main controller controls the GUI unit/sequence operation of the system (EBI). The main controller receives an operation instruction from a host computer in a factory or from the GUI. The main controller gives a necessary instruction to the VME controller and the IPE controller. The VME controller controls the operations of the components of the system (EBI). The VME controller gives an instruction to the stage controller and the PLC controller according to the instruction from the main controller. The IPE controller obtains information on a defect inspection from the IPE node computer according to the instruction from the main controller and classifies the obtained defect information and displays the image. The IPE node computer obtains the image supplied from the TDI camera and performs the defect inspection.

The PLC controller obtains the driving information of the units such as bulb and the sensor information upon receipt of the instruction from the VME controller. The PLC controller monitors malfunction of the vacuum degree which needs full-time monitoring. The stage controller moves the stage in the XY direction upon receipt of the instruction from the VME controller and rotates a wafer put on the stage.

Thus, in this embodiment, a distributed control system is formed. When the component of the peripheral device is changed, each interface among the respective controllers is kept in the same state. Therefore, it is unnecessary to change the software and the hardware of the upper controller. Even when a sequence operation is added or modified, the upper software and hardware are changed at the minimum. Thus, it is possible to cope with a change of the component flexibly.

2-4-5) Structure of User Interface

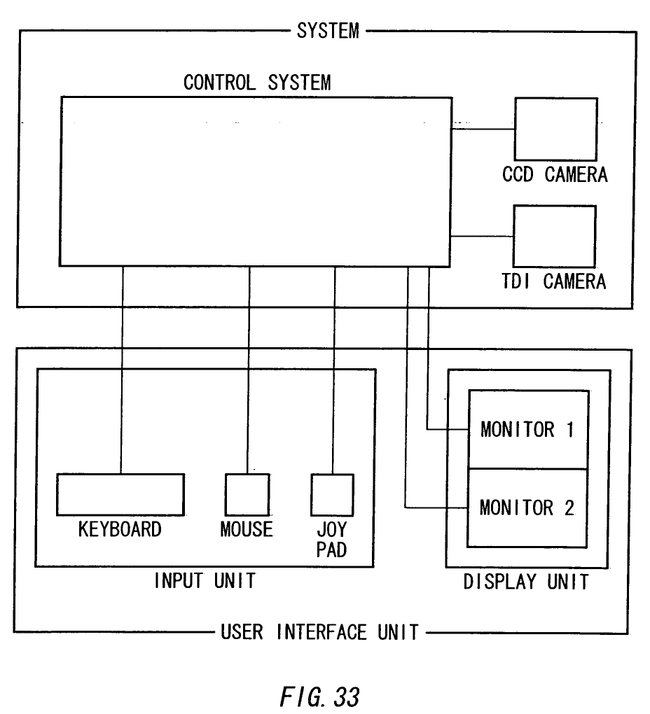

FIG. 33 shows the structure of a user interface.

(1) Input Unit

The input unit is a device for receiving an input from a user, and formed by a “keyboard”, a “mouse”, and a “JOY pad”.

(2) Display Unit

The display unit is a device for displaying the information to a user, and formed by two monitors.
Monitor 1: display an image obtained by the CCD camera or the TDI camera
Monitor 2: GUI display

About Coordinate

This system defines the following three coordinate systems.

(1) Stage Coordinate System [Xₛ, Yₛ]

Reference Coordinate System for Specifying the Position at a Time of Controlling the Position of the Stage

The left bottom corner of the chamber is the original point. The X coordinate value is increased in the right direction and the Y coordinate value is increased in the upper direction.

This system includes only one coordinate system. The position (coordinate) shown by the stage coordinate system is supposed to be at the center of the stage (the center of a wafer).

Specifically, when the coordinate [0, 0] is specified in the stage coordinate system, the stage is moved so that the center of the stage (center of a wafer) may overlap with the original point of the stage coordinate system.

The unit is defined as [μm]. The minimum resolution is defined as λ/1024 (≅0.618 [μm])

*λ: wavelength of laser used in the laser interferometer (λ=632.991 [μm])

(2) Wafer Coordinate System [Xw, Yw]

Reference Coordinate for Specifying the Position for Observing (Imaging and Displaying) the Surface of a Wafer

With the center of a wafer as the original point, the X coordinate is increased in the right direction and the Y coordinate is increased in the upper direction.

The position (coordinate) shown in the wafer coordinate system is the center of the image taken by the imaging device (CCD camera or TDI camera) selected at that time.

This system includes only one coordinate system.

The unit is defined as [μm] and the minimum resolution is defined as λ/1024 (≅0.618 [μm]).

*λ: wavelength of laser used in the laser interferometer (λ=632.991 [μm])

(3) Die Coordinate System [X_{D}, Y_{D}]

Reference Coordinate for Defining the Position of Observation (Imaging and Displaying) in Each Die

The left bottom corner of each die is the original point. The X coordinate is increased in the right direction and the Y coordinate is increased in the upper direction. This coordinate system exists in every die. The unit is defined as [μm]. The minimum resolution is defined as λ/1024 (≅0.618 [μm]).

λk: wavelength of laser used in the laser interferometer (λ=632.991 [μm])

Numbering is performed on each die on a wafer. A die that is a reference of the numbering is called the original die. In default, the original die is a die nearing to the original point of the wafer coordinate system. According to the user's instruction, the position of the original die can be selected.

* The relationship between the coordinate instructed by the user interface and the stage moving direction is as follows.

(1) JOY Stick & GUI Arrow Button

The direction indicated by the JOY stick and the GUI arrow button is regarded as the direction an operator wants to see. The stage is moved in the direction contrary to the indicated direction.

(Example) Indicated direction: right . . . stage moving direction: left (image is moved left and view is moved right) Indicated direction: upper . . . stage moving direction: down (image is moved down and view is moved up).

(2) Direct Input of Coordinate on GUI

The coordinate directly input on the GUI is the position where an operator wants to see on the wafer coordinate system. Then, the stage is moved so as to show the coordinate of the wafer at the center of the pick-up image.

2-5) Inspection

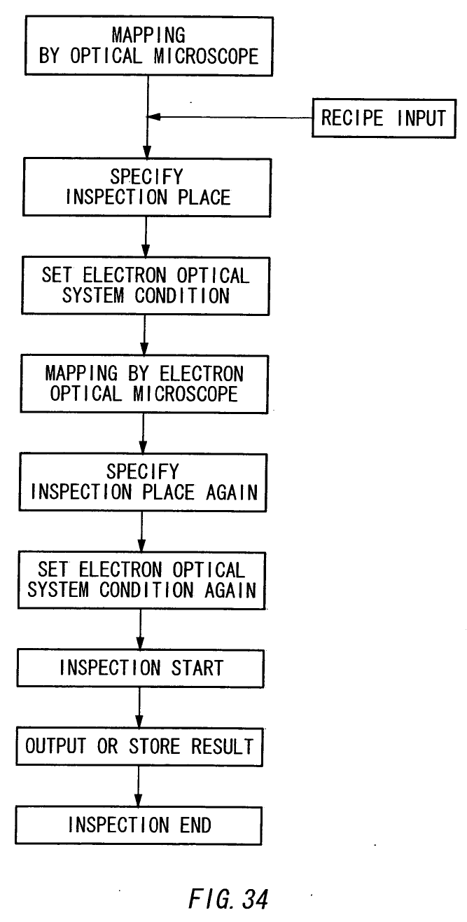

The inspection procedure will be described by using FIG. 34, this time. At first, the general inspection procedure will be described and then, the selective inspection will be described. The defect inspection system by using the electron beams is generally expensive. The throughput thereof is lower than that of the other processor. Therefore, at the present, a defect inspection is performed after the important process most requesting an inspection. The important process includes, for example, etching, deposition, or CMP (chemical and mechanical polishing), planarization, and the like. In the wiring process, the defect inspection is performed in a much finer wiring process. The defect inspection is performed in one or two process of the wiring process. The defect inspection is performed also in the gate wiring process of the front end processing. In particular, when the design rule is 100 nm and less, it is important to find a configuration defect and an electrical defect and further it is important to feed back the detected result to the process. In this case, a configuration defect and an electrical defect can be satisfactorily inspected as for the wiring having the width of 100 nm and less and the via hole having the diameter 100 nm and less.

A wafer to be inspected is aligned on an ultra-precise X-Y stage through the atmospheric transfer system and the vacuum transfer system. Then, the wafer is fixed through the electrostatic chuck mechanism. Thereafter, the defect inspection will be performed according to the procedure of FIG. 34. At first, the position of each die is confirmed by the optical microscope depending on necessity and its result is stored. The height of each position is detected and the detected result is stored. Further, the optical microscope acquires the optical microscopic image of a defect at a desired position. The optical microscopic image is used for comparison with the image of the electron beams. Conditions of the electron optical system are set. Information set by the optical microscope is modified by using the image of the electron beams, hence to improve the accuracy.

Next, information of recipe depending on the type of a wafer (for example the type depends on process (such as the wafer after which process) and also the type may depend on the wafer size such as 200 mm or 300 mm) is entered into the system. The device specifies an area to be inspected, sets the electron optical system, and sets the inspection condition. While obtaining the image, generally the system inspects a defect at real time. In the case of the general inspection on the whole surface of a wafer, comparison between cells and comparison between dies are performed. The inspection is performed through a rapid information processing system having algorithm. Depending on necessity, the result is output to the CRT. The result is stored in a memory.

A defect includes a particle defect, a configuration defect (pattern defect), and an electrical defect. The electrical defect means break and cable malfunction of the wiring or via. These can be automatically distinguished at real time. Also the size of a defect and a killer defect can be automatically classified at real time. The killer defect is so serious a defect that the chip becomes impossible to use. In this embodiment, it is effective in classifying the defects of the wiring, in particular, having the wire width 100 nm and less and the via having the diameter 100 nm and less. Detection of the electrical defect is achieved by detecting the abnormal contrast. For example, by irradiating the electron beam (approximately 500 eV), the position of a cable malfunction is generally charged positively, hence to reduce the contrast. As a result, it can be distinguished from the position of the normal cable. The electron beam irradiating means in this case is the electron beam generating means of low potential (low energy) provided separately from the general electron beam irradiating means for usual inspection. This electron beam generating means (thermal electron generation, UV/photoelectron) is provided in order to distinguish contrast by a difference of potential. Before irradiating the area to be inspected with the electron beams for inspection, the electron beams of low potential is generated and irradiated. The energy of the electron beams is, for example, 100 eV and less. By irradiation with the electron beams for inspection, there may occur the positive electric charge. In some of the specifications, it is not necessary to provide another electronic beam generating means of low potential as mentioned above. By applying the positive or negative potential as for a reference potential to a sample such as a wafer, there occurs a difference in contrast. This is caused by a difference in smoothness of flow of device in the forward direction and the backward direction. This difference in contrast enables the detection of defect.

The contrast caused by the potential difference may be converted into an image of a signal effective in displaying the data of potential contract. The converted image may be displayed. The image of the potential contrast is analyzed, and when the potential is higher than the expected value or lower than it, its solid structure is identified. The type of defect, isolation fault and cable fault, is identified. For example, the potential contrast images are obtained from various dies on a wafer. A defect is recognized through the detection of their difference. By using the design data such as the CAD data, the image data equal to the potential contrast image of the inspected die is created. This system detects a difference between this image data and the potential contract image obtained from the inspected die on a wafer. Thus, a defect is recognized.

This embodiment can be used for a line width measuring device and for measurement of alignment accuracy. The information of a wafer to be inspected is stored and managed. The information of a wafer includes, for example, the number of a cassette and the number of a wafer (or lot number). The memory controller is storing and controlling where and how a wafer is at the present. Therefore, such a trouble as performing an inspection twice or more by mistake or missing an inspection can be prevented.

2-6) Inspection Method

2-6-1) Outline

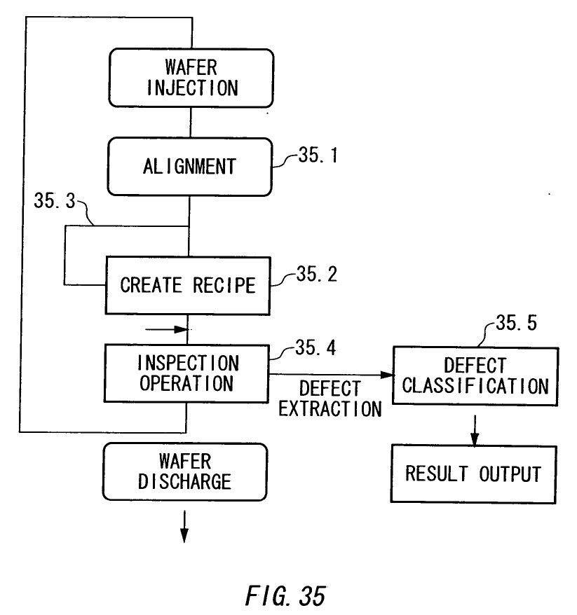

FIG. 35 shows the basic flow of the inspection. After a wafer transferring including the alignment operation 35.1, a recipe is created (35.2). In the recipe, the conditions concerned about the inspection are set. A wafer to be inspected requires at least one kind of recipe. In order to cope with a plurality of inspection conditions, there may exist a plurality of recipes as for one inspected wafer. When there are a plurality of inspected wafers of the same pattern, the wafers may be inspected with one kind of recipe. The path 35.3 in FIG. 35 shows that it is not necessary to create a recipe just before the inspection operation when an inspection is performed with the recipe having been created in the past. In FIG. 35, the inspection operation 35.4 performs the inspection of a wafer according to the condition and sequence described in the recipe. Extraction of a defect is performed at once every time a defect is found during the inspection. In the defect extraction processing, the following operations are performed in parallel.
a) Defect is classified (35.5) and the extracted defect information and the defect classification information are added to the result output file.
b) Extracted defect image is added to the result output file for image exclusively or a file.
c) Defect information such as the position of the extracted defect is displayed on the operation screen.

When the inspection is finished by the unit of a wafer to be inspected, the following operations are performed.
a) The result output file is closed and stored.
b) When the outward communication requires the inspection result, the inspection result is sent.
c) A wafer is discharged.

When the setting of inspecting wafers in sequence is established, the next wafer to be inspected is carried. The above sequential operations will be repeated.

Hereinafter, the flow of FIG. 35 will be described further.

(1) Creation of Recipe

A recipe is a setting file of conditions about an inspection. A recipe can be stored. At a time of inspection or before inspection, a recipe is used so as to set the system. In the case of the general inspection on the whole wafer surface, the following conditions about the inspection are described in the recipe.
a) Die to be inspected
b) Area to be inspected within die
c) Inspection algorithm
d) Detection condition (sensitivity of inspection and the other necessary conditions for extraction of defect)
e) Observation condition (various conditions necessary for observation such as magnification, lens voltage, stage speed, and inspection order)

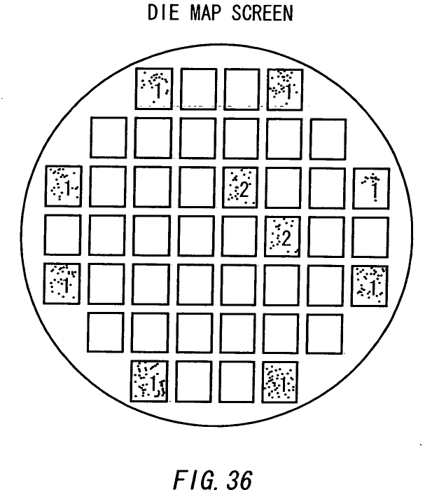

Of the above, a die to be inspected is set by an operator, as illustrated in FIG. 36. An operator specifies a die to be inspected on the die map screen shown on an operation screen. In the example of FIG. 36, each die 1 on the end of a wafer is turned gray. Further, each die 2 is turned gray. The dies 2 are found to be definitely defective in the previous process. These dies 1 and 2 are deleted from the object to be inspected. The remaining dies are the objects to be inspected. The system has a function of automatically specifying a die to be inspected. This function automatically specifies a die to be inspected according to the distance from the end of a wafer or according to the good-or-bad information of a die detected in the previous process.

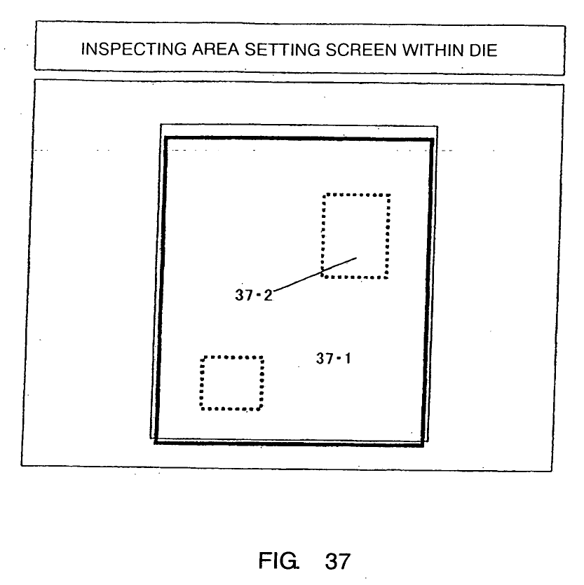

Further, the setting of an area to be inspected within a die is performed by an operator, as illustrated in FIG. 37. An operator specifies an area to be inspected on the setting screen of inspecting area within die shown on the operation screen. Further, he or she specifies the area to be inspected with an input device such as a mouse and enters it according to the image obtained by the optical microscope or the EB microscope. In the example of FIG. 37, the area 37.1 shown by a solid line and the area 37.2 shown by a dotted line are set.

The area 37.1 is set on almost the whole die. The inspection algorithm is an adjacent die comparison method (die-to-die inspection). The details of the detecting condition and the observing condition as for this area are separately set. In the area 37.2, the inspection algorithm is an array inspection (check). The details of the detecting condition and the observing condition as for the area are also set separately. Thus, a plurality of areas to be inspected can be set. These areas may be inspected individually with the respective original inspection algorithms. The individual conditions of the inspection sensitivity may be set in these areas and the setting conditions may differ. A plurality of areas to be inspected may be overlapped with each other. Therefore, the same area can be processed with the different inspection algorithms in parallel.

(2) Inspection Operation

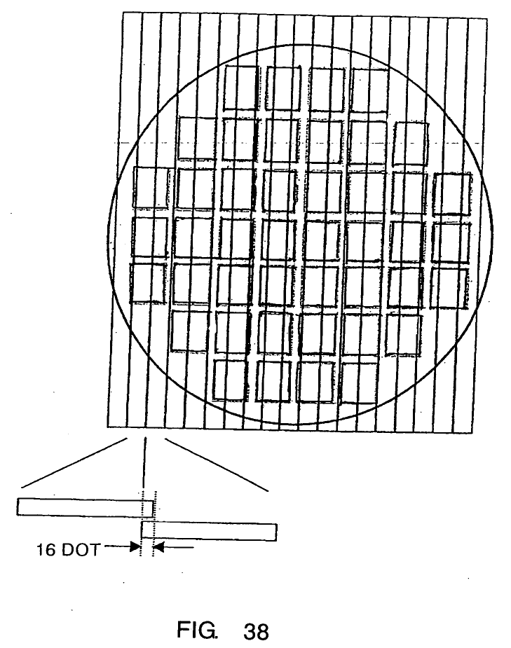

As illustrated in FIG. 38, a surface to be scanned of a wafer to be inspected is divided finer by the scanning width. The respective areas are scanned. The scanning width is determined substantially by the length of a line sensor. The scanning width is set so as to overlap with the end portion of the line sensor a little. This setting is performed in order to judge the continuance of each line in the final stage of integration processing of the detected defects. This setting is also performed in order to ensure an allowance for performing an image alignment in the comparison inspection. In the line sensor of 2048 dots, the overlap amount is 16 dots and so.

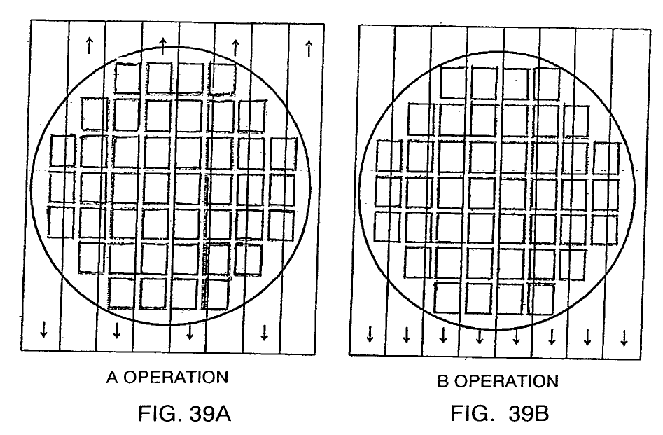

FIG. 39A and FIG. 39B schematically show the scanning direction and sequence. The bidirectional operation A is performed to shorten the inspection time. The single directional operation B is performed by a mechanical control. This system is designed in that an operator can select the bidirectional operation A and the single directional operation B.

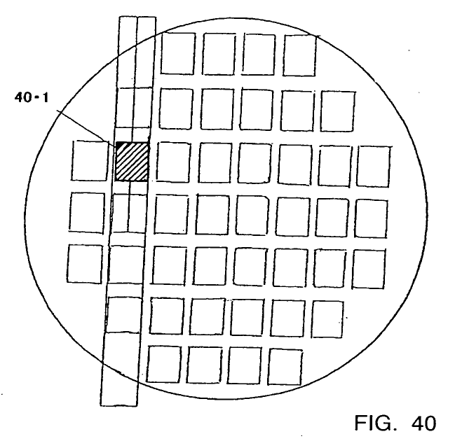

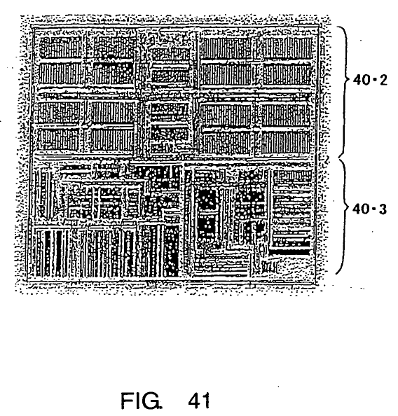

The form of this embodiment has a function of automatically calculating the operation of reducing the scanning amount according to the setting of a die to be inspected in a recipe and a function of performing an inspection by using the calculation result. FIG. 40 shows an example of scan in the case where the inspection die 40.1 is one. Unnecessary scan is not performed. FIG. 41 shows a cell unit 40.2 and a random unit 40.3.

2-6-2) About Selective Inspection Method

Hereinafter, a selective inspection method will be described. The selective inspection technique inspects not the whole surface of a wafer but some area that an operator desires to inspect. The area to be selected is, for example, an area with a condensed pattern where a defect easily occurs. The area to be selected is, in particular, an important area on a chip. This technique can shorten the inspection time extremely while inspecting an important portion accurately.

Specifically, the inspection will be performed as follows. As mentioned above, a sample (various substrates including wafers) is transferred and mounted on the stage of the inspection system. Then, positional adjustment of a sample called alignment is performed. Pattern matching is performed on the pattern formed on the sample. The rotation angle of the sample is adjusted and the positional deviation of θ is performed. A deviation on the x-y surface of a die is stored. While correcting the deviation, the inspection is performed.

The inspection of each sample is performed according to the recipes. In a recipe, various inspection conditions are defined in advance. Principally, according to the recipe, various set values and operation condition of the inspection system are determined. The set values include, for example, acceleration voltage, beam current, and set voltage of lenses. The operation condition includes a condition about which area of a sample is inspected. The inspection is performed according to the specification of a recipe.

There is a case where an operator of the inspection system knows the processing process of a sample before inspection and he or she accurately knows which position of the sample should be inspected. In this case, a recipe specifies an area to be inspected in this embodiment. According to the specification of the area to be inspected, the inspection is performed.

Generally the whole surface of a sample is inspected. As illustrated in FIG. 30B, a thinning-out inspection may be performed in some cases. In the general thinning-out inspection, only the regular stage movement and deflection is performed. For example, the stage is moved from one row to another in every other row and the whole surface of a sample is inspected.

On the contrary, in the embodiment, it is necessary to do the flexible inspection according to the specification of a critical portion in a recipe. The inspection technique of this embodiment is designed to specify the coordinate of an area to be inspected and inspect the specified coordinate.

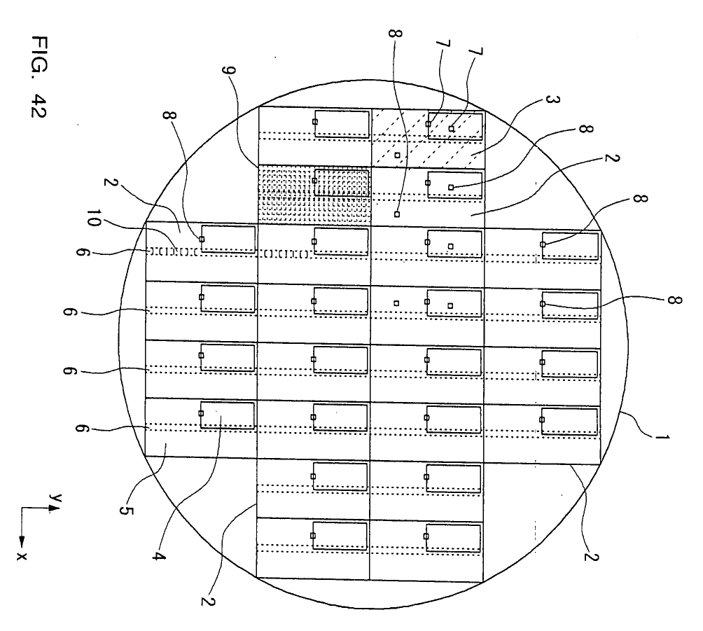

FIG. 42 shows one example of the embodiment, where this embodiment is applied to lithography. The example of FIG. 42 shows an inspection of the boundary portion of a memory cell portion and a random logic portion. A stripe including the boundary portion is inspected.

With reference to FIG. 42, a plurality of dies 2 are aligned on the wafer 1. On the wafer 1, a low pattern-density area 3 and a high pattern-density area 4 are aligned. For example, the low pattern-density area 3 corresponds to the random logic portion and the high pattern-density area 4 corresponds to the memory cell portion.

In the embodiment, an inspection omitted area is provided, as illustrated. The inspection omitted area is an area where an inspection is omitted. A stripe-shaped inspecting area 6 is established in the boundary portion between the low pattern-density area 3 and the high pattern-density area 4.

In this embodiment, a beam does not necessarily have the diameter for one pixel like SEM, but a beam having a wide width is used instead. For example, the width of a beam is large enough to realize the image area for 2048 pixel width. In the inspection of one stripe, an extremely wide area is inspected. For example, the imaging width is twice as large as the scanning width of SEM. The TDI-CCD can be used as the detector. In the embodiment, the stage is sequentially moved in synchronization with the accumulated speed of the TDI. The stage is moved in the same direction as the stripe. During this movement of the stage, the inspection is performed. Therefore, a stripe portion can be inspected sequentially at a short time. When the x-coordinate of the stripe including the critical portion can be specified, the selective inspection is performed extremely rapidly.

In the above example, there is only one stripe in the boundary portion. There may be two or three or more stripes according to the necessity. Thus, a wider area around the boundary is inspected.

The coordinate in a recipe may be arbitrarily set by an operator. The coordinate of a boundary may be automatically calculated. Since the width of a die is constant, when the x coordinate of one boundary and the width of a die are found, the coordinates of the boundary of all dies can be required by the automatic calculation.

When creating a recipe, an operator understands the past defect history in many cases. Then, a position to be inspected may be specified according to the analysis result of the history. A position which is supposed to have a lot of defects is specified and inspected. Thus, the inspection can be performed efficiently at a high degree of accuracy.

For example, the pattern density changes drastically in the boundary area between the cell portion of high pattern density and the random portion of comparatively lower pattern density. When the pattern formation is performed on a sample by the EB lithography, error of the proximity effect correction easily occurs. Even when the pattern formation is performed through the optical lithography, an error of the OPC (Optical Proximity Correction) easily occurs. In this case, the boundary area (usually x coordinate) of the cell portion and the random portion is specified as the area to be inspected. Thus, an efficient inspection can be performed.

Prediction of the position having a lot of defects is properly performed by using a simulation experiment. When there is some area where a pattern designer thinks a defect easily occurs, such area may be specified as the area to be inspected. Alternatively, when there is some area where a pattern designer thinks the most important on the pattern, such area may be specified as the area to be inspected. For example, when there is a position where the pattern is close and the line width becomes narrow or when there is a crammed position on the design, the position may be specified as the area to be inspected. The whole surface inspection of a sample and the selective inspection according to a recipe may be switchable depending on the mode.

FIG. 42 shows the areas to be inspected 7, 9, and 10 in addition to the stripe-shaped inspecting areas 6. The area to be inspected 7 is an area for the selective inspection. The inspection is performed by sequential movement of the stage, beam scan, or their combination. The area to be inspected 7 corresponds to the defect frequent area. The defect frequent area 8 is an area supposed to have defects most frequently. In the area to be inspected 9, the inspection is performed through sequential movement of the stage, beam scan, or their combination. In the embodiment, an inspection may be performed in the step-and-repeat method. The area to be inspected 10 is an example of the area for selective inspection. The area to be inspected 10 is an example of the inspecting area set as the low pattern-density area. This inspection is included in the embodiment.

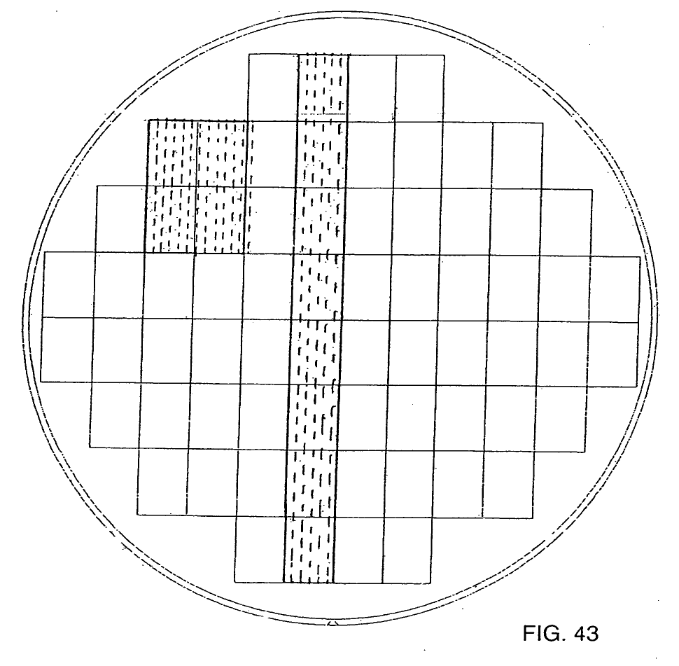

FIG. 43 shows another example of the selective inspection. In this example, an area to be inspected may not be specified in a recipe. At first, a pre-examination is performed on a predetermined small area on a sample. The result of the pre-examination is analyzed. The area including a lot of defects within a die is predicted. The predicted area is selectively inspected.

The middle of FIG. 43 shows an example of the small area where the pre-examination is performed at first. In this example, the whole surface of one or two rows of dies is inspected by repeating the inspection of the stripe width.

On the left of FIG. 43, another example is shown. In this example, further, the y coordinate is restricted. For example, the dies (the total of four dies) of two lines x two rows are inspected.

The image of the above small area is obtained. Then, a wafer map is created. The position to be inspected selectively is specified from the created wafer map, thereby enabling the inspection.

In this way, the whole inspection positions are determined according to the inspection result of the actual small area on the same sample. It is possible to select a position to be inspected in the form of reflecting the situation of the previous processing process. It is possible to flexibly cope with the actual situation.

In selecting a position to be inspected, the wafer map may be displayed on the screen. A desired area to be inspected on the wafer map may be selected through a click operation or a drag operation. The area to be inspected may be specified by an operation of surrounding it with a rectangle. These specification operations are very convenient.

The selecting processing of these areas to be inspected may be performed by automatic calculation processing. For example, the image of a small area is obtained. A memory stores the template of pattern to be inspected previously. A difference between the template and the image of the small area is calculated. A position exceeding a predetermined threshold is specified. The specified position is a candidate defective portion. An area to be inspected is determined so as to include the portion containing the largest number of the specified positions. Algorithm for this processing is prepared and executed.

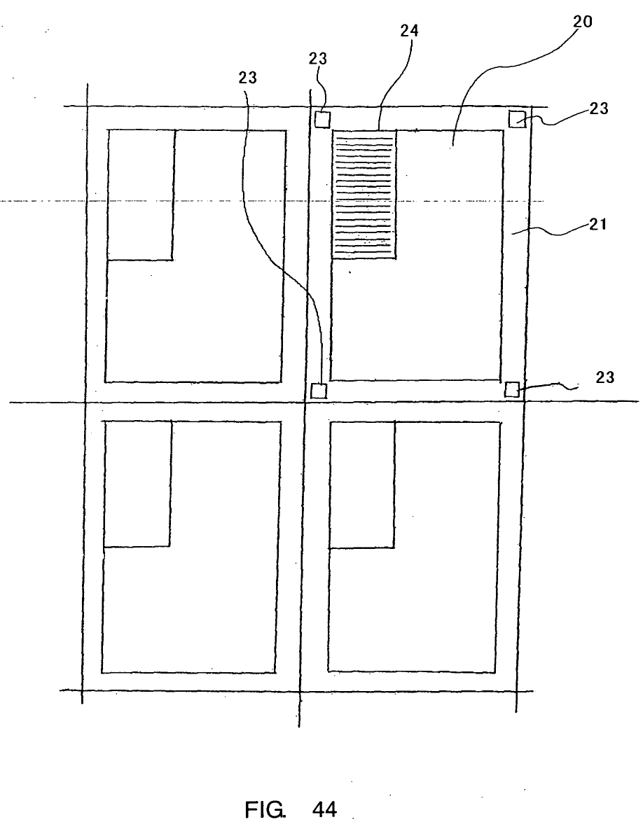

As illustrated in FIG. 44, a fine test pattern 23 for inspection may be formed on a scribe line 21 around the die 20. A stripe including this test pattern 23 may be specified as the area to be inspected. In FIG. 44, the test pattern 23 is arranged at the four corners of the die 20 including the memory cell portion 24.

The test pattern may be a finer pattern than the actual pattern within the die. This finer test pattern is formed. When a defect is not detected through the inspection of this test pattern, there is a high possibility of including no defect in the actual pattern within the die. This inspection is thus a selective inspection very effective.

The test pattern may be individually formed at the respective four corners outside each die. Thus, the test pattern is distributed to the whole sample uniformly and arranged. When there is no defect as the result of the inspection of the above test pattern, it can be judged that there is a high possibility of including no defect on the whole sample.

The form of this embodiment is an inspection system using a projective optical system. The TDI-CCD is used as the detector. When a sample is sequentially inspected by the unit of stripe while sequentially moving the stage as mentioned above, the structure of this system is very advantageous. This inspection method is the most suitable for this system. The movement of the stage, however, may be performed in the step-and-repeat method. Only a critical area may be selected and inspected, or a spotted area may be selected and inspected.

Electrons used for the inspection are the electrons discharged from a sample when the sample is irradiated with the primary electron beam. The discharged electrons include, for example, the secondary electrons, the reflected electrons, and the back scattered electrons. Besides, electrons used for the inspection may be the electrons obtained when a reverse electric voltage is applied to the vicinity of a sample. These electrons are reflected before the primary electron beams come into collision with a sample at the application of the reverse electric voltage near the sample. The electron is also called a mirror electron. Moreover, the inspection can be performed by using the transmitted electrons which have been filtering through a sample. In order to use the above electrons, the setting of lens and retarding may be changed depending on necessity, or a necessary hardware may be added or changed.

The inspected image is once taken into a memory. The image taken into the memory is compared with the next taken image. In other word, in this processing, two images obtained before and after the die in the same stripe are compared with each other. Alternatively, comparison may be made between the images obtained from the different stripes on the same sample. Alternatively, comparison may be made between the images obtained from the stripes on the different samples. Or, the image obtained by the inspection may be compared with the image in the stripe of the design data. A comparison inspection is performed in this way.

In order to shorten the inspection time, a thinning-out inspection or a sampling inspection may be performed. In this case, the rate of thinning out or the rate of sampling is previously determined. According to the thinning-out rate, a plurality of spaced stripes are inspected. Each stripe is inspected in every predetermined space.

In this case, since a stripe that is an area to be inspected is automatically determined, a critical portion is not always inspected. Therefore, accuracy becomes lower than in the above-mentioned selective inspection. However, shortening the inspection time can be realized and the area to be inspected is easily specified. Only when the cut-back in the inspection time is made much of, this inspection is effective. The system is a image projective inspection device. The width of one line of stripe is much wider than that of SEM. Therefore, the inspection time can be extremely shortened.

As mentioned above, the selective inspection method and system of the embodiment is preferably applied to the image projective inspection system using the electron beams. It can be applied also to the inspection system using the other method. In this case, an area to be inspected is freely set. A stripe may be inspected by using the SEM beams narrowing down.

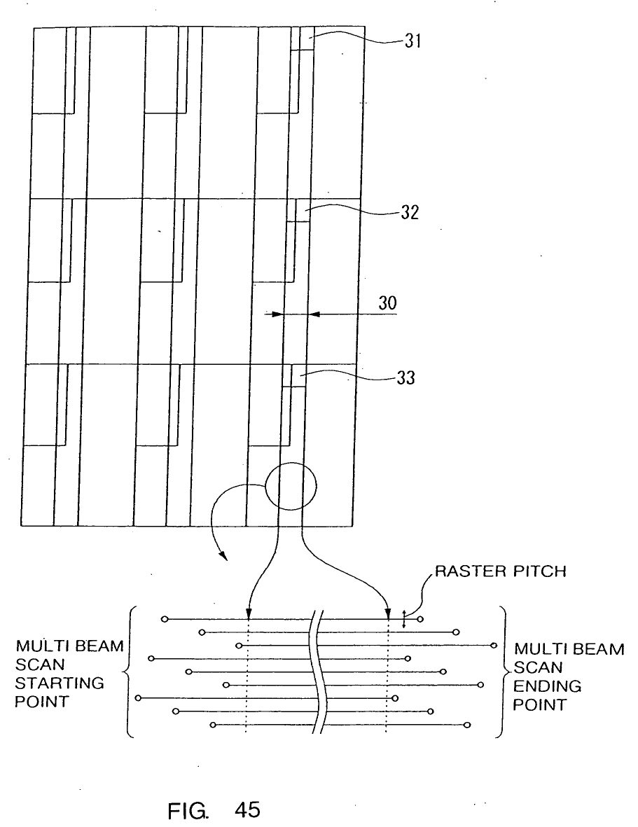

In the SEM method of one beam, there is a case where the inspection speed is low. In this case, for example, the number of beams is increased. In other word, an illumination source for multi beams is provided. As illustrated in FIG. 45, each raster is simultaneously scanned with a plurality of beams. Images are synthesized by processing and combining the detection signals while considering the beam position.

FIG. 45 shows an example of the inspection using the multi beams. This example selectively inspects a place supposed to have a lot of defects. A scan start point and a scan end point are determined so as to scan the stripe width 30 with all nine beams. All nine beams are scanned simultaneously. The secondary electrons are detected by the nine detectors from the respective scan points in a state free from crosstalk. The signals from the respective detectors are combined into the SEM image. The areas 31, 32, and 33 are separately set. The SEM images of these areas 31, 32, and 33 are compared with each other. A defect candidate of the image of the area 32 is required. The defect candidate is a portion, of the image of the area 32, different from the image of the area 31 and the image of the area 33.

Further, multi beam technology may be used in the image projective inspection system used in this embodiment. In the image projective system, the diameter of the original beam is large. Moreover, a sample is irradiated with a plurality of beams. Therefore, the inspection time can be extremely shortened.

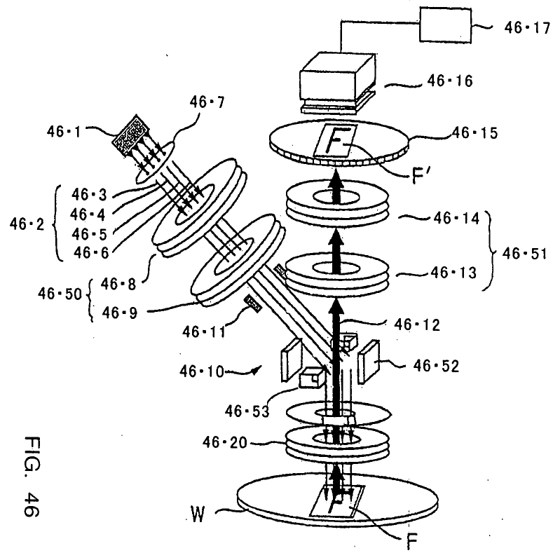

FIG. 46 shows an example of the image projective multi-beam inspection system. Four electron beams 46.2 (46.3 to 46.6) are emitted from the electron gun 46.1. The four electron beams 46.2 are shaped by an aperture 46.7 and imaging is performed through two steps of lenses 46.8 and 46.9 (lens system 46.50). The image is formed on the central surface of deflection of the Wein filter 46.10. The shape of the image is 10 μm×12 μm ellipse.

The deflector 46.11 performs a raster scan of the electron beam in a direction vertical to the paper surface of the drawing. The four electron beams are imaged so that the four electron beams in whole may cover the rectangular area of 1 mm×0.25 mm uniformly. These electron beams are deflected by the E×B separator (Wein filter) 46.10. Crossover of these electron beams is established by the NA and reduced in ⅕ scale by the lens 46.20. A plurality of electron beams are emitted and projected so as to cover the sample W of 200μ×50 μm in a way of being vertical to the surface of the sample (this is called Koehler illumination). The E×B separator 46.10 is provided with the electrode 46.52 and the electromagnet 46.53.

Four secondary electron beams 46.12 are emitted from the sample. The secondary electron beams 46.12 have the information of the pattern image (sample image F). The electron beams 46.12 are magnified by the lenses 46.11, 46.13, and 46.14. The lens 46.13 and the lens 46.14 are the lens system 46.51. The electron beams 46.12 are imaged on the MCP 46.15. The four electron beams 46.12 are combined into an image and form a rectangle image (magnified projected image F′) as a whole.

The magnified projected image F′ by the secondary electron beam 46.12 is 10000 times more sensitized by the MCP 46.15 and converted into light through a fluorescent unit. The magnified projected image F′ becomes an electric signal in synchronization with the continuous transfer speed of the sample by the TDI-CCD 46.16. The image display unit 46.17 obtains the sequential images of the magnified projected image F′. The sequential images are supplied to the CRT and the like.

The electron beam irradiating unit has to illuminate the surface of the sample as uniformly as possible in order to reduce the illumination nonuniformity. Further, a rectangular or ellipse area has to be irradiated with the electron beams. In order to enhance the throughput, much more current has to be used to irradiate the illumination area.

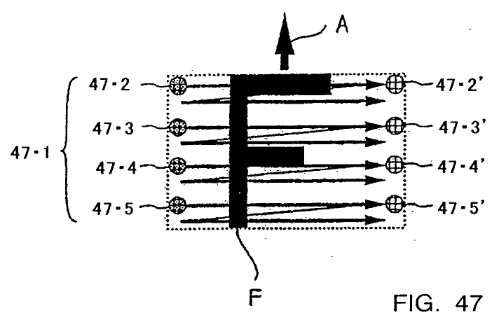

FIG. 47 shows an example of the primary electron beam irradiation method according to the form of the embodiment. The primary electron beam 47.1 is formed by four electron beams 47.2 to 47.5. Each shape of the beams is 2 μm×2.4 μm ellipse. One beam is used to do a raster scan at the rectangle area 200 μm×12.5 μm. The illumination areas are added to each other so that they do not overlap with each other. As a whole, the rectangle area 200μ×50 μm is irradiated.

In FIG. 47, the beam 47.2 arrives at the beam 47.2′ at a limited time. The beam returns to a position just below the 47.2 without losing any time. The vertical deviation at this time corresponds to the beam spot diameter (10 μm). The beam again moves at the same limited time as in the previous scan. At this time, the beam is shifted to the position just below the 47.2′ in parallel to the beam 47.2 to 47.2′ (the position is in a direction toward the 47.3′). This operation is repeated. One fourth of the rectangle illumination area (dotted line of FIG. 47) is scanned (200 μm×12.4 μm). The beam is returned to the starting point 47.1. These operations are repeated at high speed.

The other electron beams 47.3 to 47.5 repeat the scan at the same speed as the electron beam 47.2. The rectangle illumination area (200μ×50 μm) of the drawing is uniformly irradiated at high speed.

When the uniform irradiation is realized, there is no need to do the above raster scan. For example, a scan may be performed in a way of drawing Lissajous figure. The moving direction of the stage does not have to be the direction A shown in FIG. 47. Namely, the moving direction of the stage does not have to be vertical to the scanning direction (the horizontal rapid scanning direction in FIG. 47).

In this embodiment, the illumination nonuniformity of the electronic beams is about ±3%. The illuminating current is 250 nA per one electronic beam. The current 1.0 μA can be achieved (twice as much as in the conventional art) on the whole surface of a sample by using the four electron beams. By increasing the number of electron beams, the current can be increased and the throughput can be enhanced. The illuminating point is smaller (about 1/80 in area) than in the conventional art and it is moved. Thus, the charge-up can be restrained to less than 1/20 of that of the conventional art.

When the detected electron obtains the information on the surface of a substrate, the detected electron may be of any type, and for example, it may be the mirror electron. The mirror electron is an electron which reflects in the vicinity of the substrate without coming into direct collision with the substrate when a reverse electric field is formed there. The mirror electron means a reflected electron in a broad sense. Alternatively, the detected electron may be a transmitted electron and the like. The transmitted electron penetrates through the substrate.

In the case of using, in particular, the mirror electron, the electron does not come into direct contact with the sample. Therefore, it has an advantage that this is not so much affected by the charge up.

In the case of using the mirror electron, a negative potential is applied to a sample. This forms a reverse electric field in the vicinity of the sample. This negative potential is set lower than the acceleration voltage. The negative potential should be set at a value where almost all the electron beams are returned in the vicinity of the substrate surface. Specifically, this negative potential may be set at a potential lower than the acceleration voltage by 0.5 to 1.0 V and more. For example, in the embodiment, when the acceleration voltage is −4 kV, it is preferable that the applied voltage to a sample is set at −4.000 kV to −4.050 kV. More preferably, the applied voltage is set at −4.0005 kV to −4,020 kV. More preferably, it is set at −4.0005 kV to −4.010 kV.

3) Embodiment of Production Line

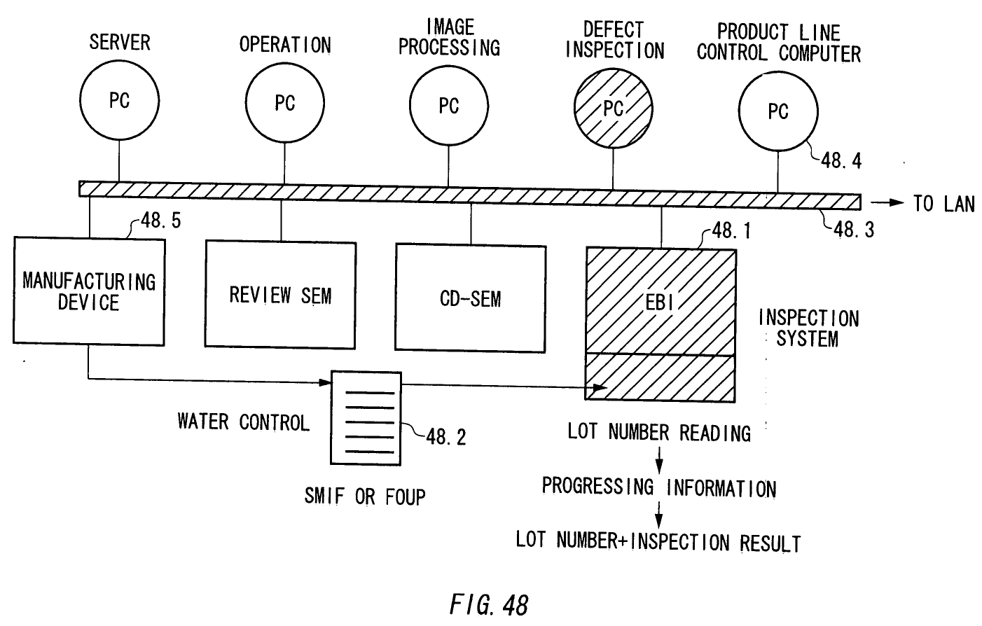

FIG. 48 shows an example of the production line using the system of the invention. A wafer is inspected by the inspection system 48.1. The information of the wafer is read out from a memory provided in the SMIF or the FOUP 48.2. The information of the wafer includes the lot number and the production device history. The production device history is the information concerned with the production. Alternatively, the lot number of the wafer may be recognized by reading the SMIF, FOURP, or the ID number of a wafer cassette. During transfer of the wafer, the amount of water is controlled, hence to prevent oxidation of the metal wiring.

The defect inspection system 48.1 can be connected to a network system of the production line. The inspection system can send the wafer information that is an object to be inspected and its inspection result through the network system 48.3. The wafer information includes the lot number. The wafer information and the inspection result are sent to a computer 48.4 for the production line control which controls the product line, and further, to each manufacturing device 48.5 and another inspection device. The manufacturing device includes a lithography concerned device (for example, exposure equipment), a coater, a curing oven, and a developer, and further it includes a deposition device such as an etching device, a sputtering device, and a CVD. It further includes a CMP device, various measuring devices, another inspection device, and a review device.

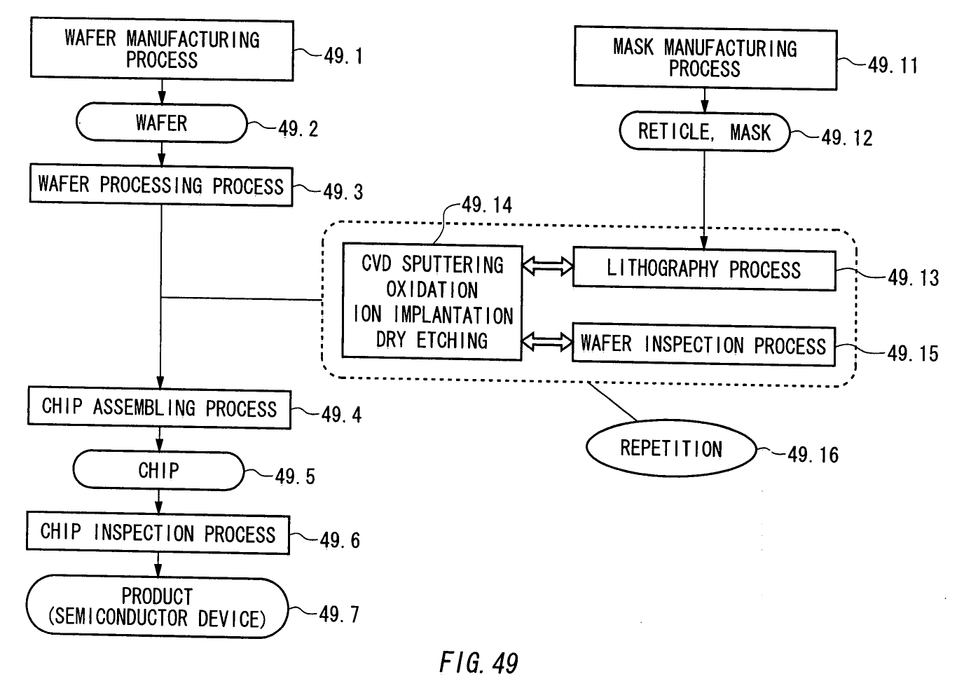

FIG. 49 is a flow chart showing an example of the semiconductor device manufacturing method using the electron beam device according to the embodiment of the invention. The semiconductor device manufacturing method in FIG. 49 includes the following main processes.

(1) Wafer manufacturing process 49.1 for manufacturing a wafer 49.2

or wafer preparing process for preparing a wafer 49.2

(2) mask manufacturing process 49.11 for manufacturing a mask (reticle) 49.12 used for exposure

or mask preparing process for preparing a mask

(3) Wafer processing process 49.3 for performing necessary processing on a wafer

(4) Chip assembling process 49.4 for cutting away each chip formed on a wafer one by one and enabling the operation of the chip

(5) Chip inspection process 49.6 for inspecting a chip 49.5 and process for manufacturing a product (semiconductor device) 49.7 formed by the chips that have passed the inspection

The above main processes respectively include each some sub-processes. The right portion of FIG. 49 shows the sub processes of the wafer processing process 49.3.

In these main processes (1) to (5), the wafer processing process 49.3 is the main process which decisively influences the performance of the semiconductor device. In this process, each circuit pattern designed is sequentially stacked on the wafer. A lot of chips are formed. A chip works as a memory and an MPU. The wafer processing process includes the following processes.

(6) Thin film forming process 49.14 (CVD and sputtering) for forming a dielectric thin film and a metal thin film

The dielectric thin film becomes an insulating layer. The metal thin film forms the wiring unit and the electrode unit.

(7) Oxidation process 49.14 for oxidizing this thin film layer and a wafer substrate

(8) Lithography process 49.13 for forming a resist pattern by using a mask (reticle)

A mask is used for processing a thin film layer and a substrate selectively.

(9) Etching process 49.14 (for example, dry etching technique) for processing a thin film layer and a substrate according to a resist pattern

(10) ion/impurity implantation diffusion process 49.14

(11) Resist striping process

(12) Inspection process for inspecting a processed wafer

The wafer processing process 49.3 is repeated for the number of times according to the number of necessary layers. Thus, a semiconductor device is manufactured so as to operate as designed.

In the flow chart of FIG. 49, the above processes (6), (9) and (10) are shown as one block 49.14. As illustrated in FIG. 49, an additional wafer inspection process 49.15 is included. Further, the repetition process is represented by the block 49.16. The above inspection process (12) uses the inspection system of this embodiment. Even when a semiconductor device having a fine pattern is inspected, this inspection system can inspect all devices with high throughput. It can improve the yield of a product and prevent from shipment of a defective product.

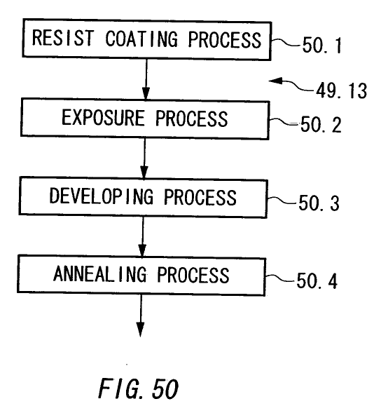

FIG. 50 shows the detail of the lithography process 49.13 in the manufacturing method of FIG. 49. As illustrated in FIG. 50, the lithography process 49.13 includes the following processes.

(13) Resist coating process 50.1 for covering with resist a wafer having the circuit patterns formed in the former process

(14) Exposure process 50.2 for exposing a resist

(15) Developing process 50.3 for developing an exposed resist to obtain a resist pattern

(16) Annealing process 50.4 for stabilizing a developed resist pattern

The semiconductor device manufacturing process, the wafer processing process, and the lithography process are the well known processes.

As mentioned above, a preferred embodiment of the invention has been described. As described with reference to FIG. 42 and FIG. 45 mainly, in the embodiment, the selective inspection is performed and not only the whole surface of a sample but also a selected area can be inspected. Depending on the purpose of use of the inspection system, only a critical area where an inspection is requested, in particular, can be inspected selectively. With the accuracy at a constant level, the inspection time can be extremely shortened. When an area to be inspected is restricted, only a desired area can be inspected. This inspection system can inspect only a necessary area efficiently.

As the image projective method is used and the TDI-CCD is used as the detector, it is possible to perform an inspection while sequentially moving the stage. From this viewpoint, in the conventional partial inspection, a stage is moved in a step-and-repeat way. In this case, after the stage is moved, its vibration tends to affect the inspection. On the contrary, in this embodiment, an inspection can be performed without being bothered by this vibration, as in the whole surface inspection. Since the illumination area of beam is wide, one stripe can cover the critical area. This can realize high throughput and high inspection accuracy.

In this way, this embodiment enables the inspection with high throughput at a high degree of accuracy in reply to the demand.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

1. A sample surface inspection method for inspecting a sample surface, comprising:
selecting some area on the sample surface as an inspecting area,
irradiating the selected inspecting area with electron beam,
detecting electron having information on the sample surface,
creating an image of the sample surface based on the detected electron, and
performing a comparison inspection, comparing the created image with a reference image.

2. The sample surface inspection method according to claim 1, in which
the selecting step selects the inspecting area according to an instruction of a predetermined recipe.

3. The sample surface inspection method according to claim 1, in which
the selecting step selects the inspecting area by the unit of stripe in inspecting a substrate.

4. The sample surface inspection method according to claim 1, in which
the irradiating step irradiates the sample with the electron beam moving the electron beam or the sample so that the electron beam relatively shifts on the sample.

5. The sample surface inspection method according to claim 1, in which
the detecting step detects the electron by projecting the electron beam on a projection surface including a plurality of pixels.

6. The sample surface inspection method according to claim 1, in which
the irradiating step irradiates the inspecting area with the electron beam having such an area that the illumination area of the electron beam includes a plurality of pixels on a detector.

7. The sample surface inspection method according to claim 3, in which
the comparing step uses the image of a die within the same stripe where the created image is created as the reference image.

8. A sample surface inspection method for inspecting a surface of a sample, comprising:
inspecting a small area arbitrarily selected on a sample by using electron beam to obtain an image of the small area,
specifying an area having a lot of defects from the image of the small area,
calculating and specifying an area supposed to be much defective on the whole surface of the sample, from the above area specified in the small area, and
irradiating the area supposed to be much defective on the whole surface of the sample with the electron beam to inspect the surface of the sample.

9. A sample surface inspection system for inspecting a surface of a sample, comprising:
an electron gun for irradiating a sample with electron beam,
a sample stage for holding the sample,
a detector for detecting the electron having information on the sample surface through irradiation of the electron beam toward the sample,
an image creating unit for creating an image of the sample surface based on the electron detected by the detector, and
a comparison inspection unit for comparing the created image with a reference image, and
a controller for performing a control so as to inspect some area on the sample surface selectively.

10. The sample surface inspection system according to claim 9, in which
some area on the sample surface is selected according to an instruction of a recipe.

11. The sample surface inspection system according to claim 9, in which
some area on the sample surface is selected by the stripe unit in inspection.

12. The sample surface inspection system according to claim 11, in which
the controller controls deflection of the electron beam and/or movement of the stage so as to irradiate the stripe on the sample with the electron beam.

13. The sample surface inspection system according to claim 9, in which
the detector is a CCD sensor or a TDI-CCD sensor.

14. The sample surface inspection system according to claim 9, in which
the electron gun irradiates the sample with the electron beam having an illumination area including a plurality of pixels.

15. The sample surface inspection system according to claim 9, in which
the stage sequentially moves at least in one direction on an x-y surface during the inspection.

16. The sample surface inspection system according to claim 9, further comprising
a calculation unit which specifies an area having a lot of defects from an image of some small area on the sample, calculates a positional relation between the above area and a die, and specifies an area supposed to be much defective on the whole sample.

17. A device manufacturing method comprising steps of
a. preparing a wafer,
b. performing a wafer process,
c. inspecting the wafer passing through the process, according to the method as claimed in claim 1,
d. repeating the above b and the above c, and
e. assembling a device.
